(19) United States
(12) Patent Application Publication
(10) Pub. No.: US 2026/0119384 A1
(43) Pub. Date: Apr. 30, 2026

(54) STRUCTURED TRACING AND DEBUGGING OF ARTIFICIAL INTELLIGENCE (AI) AGENT RESPONSES

(71) Applicant: BOOMI, LP, Conshohocken, PA (US)

(72) Inventors: Steven LUCAS, Denver, CO (US); Edward MACOSKY, Livermore, CA (US); Madhav SBSS, Austin, TX (US); Lomesh AGRAWAL, Toronto (CA); Deepali RAI, Bangalore (IN); Ching-Han TU, San Diego, CA (US)

(73) Assignee: BOOMI, LP, Conshohocken, PA (US)

(21) Appl. No.: 19/313,144

(22) Filed: Aug. 28, 2025

(30) Foreign Application Priority Data
Oct. 25, 2024 (IN) 202411081537
Oct. 25, 2024 (IN) 202411081538

(51) Int. Cl. G06F 11/3698; G06F 11/32

(52) U.S. Cl. CPC G06F 11/3698; G06F 11/323

(57) ABSTRACT

State-of-the-art tracing systems struggle with the analysis and visualization of the debugging data for artificial intelligence (AI) agents. In an embodiment, a trace engine obtains telemetry data during execution of an AI agent, and generates a hierarchical trace structure, comprising a decision trace structure representing a decision layer of the AI agent, an operation trace structure representing an operation layer of the AI agent, and an implementation trace structure representing an implementation layer of the AI agent. A visual debugging interface may query this hierarchical trace structure to generate one or more interactive visual elements for debugging of the AI agent.

### CROSS-REFERENCE TO RELATED APPLICATIONS

The present application claims priority to Indian Patent Application number 202411081537, filed on Oct. 25, 2024, and Indian Patent Application number 202411081538, filed on Oct. 25, 2024, which are both hereby incorporated herein by reference as if set forth in full.

### BACKGROUND

### Field of the Invention

The embodiments described herein are generally directed to artificial intelligence (AI) agents, and, more particularly, to the structured tracing and debugging of AI agents, including visualization.

### Description of the Related Art

A number of platforms exist that enable users to develop artificial intelligence (AI) agents. An AI agent is a software entity that utilizes artificial intelligence to autonomously perform one or more tasks, in order to achieve an objective set by a human, another software entity (e.g., another AI agent), or other system. An AI agent may comprise or communicate with one or more integrated, local, or remote AI models, such as generative AI models (e.g., generative language models, generative image models, generative coding models, etc.). An AI agent may also communicate with one or more tools that are external to the AI agent, to complete tasks in furtherance of its objective. The AI agent may communicate with an AI model and/or tool using an application programming interface (API).

Naturally, during development of an AI agent, it is important for the developer to debug the AI agent. Debugging refers to the identification and removal of errors in the execution of the AI agent. Traditionally, this requires the developer to review traces of the AI agent's execution. A trace is a record of the sequence of operations, performed by the AI agent, and events that occur during execution of the AI agent.

State-of-the-art tracing systems provide limited insights into the decision-making process of the AI agent and lack context for individual actions taken by the AI agent. These systems struggle with unstructured debugging data, which makes it difficult to systematically analyze execution information. In addition, the lack of relationships between execution components hinders an understanding of the full chain of reasoning by the AI agent. Furthermore, text-based logs and simple linear representations are unable to provide effective visualization of the complexity of agentic behavior, which makes it challenging to comprehend, for example, branching decision paths and relationships.

### SUMMARY

Accordingly, systems, methods, and non-transitory computer-readable media are disclosed for the structured tracing and debugging of AI agents, including visualization.

In an embodiment, a method comprises using at least one hardware processor to, for each of one or more artificial intelligence (AI) agents: obtain telemetry data for the AI agent executing in a computing environment, wherein the telemetry data comprise a trace for the AI agent, and wherein the trace comprises a plurality of spans that represent operations performed by the AI agent during execution; by a trace engine, based on the trace, generate a hierarchical trace structure comprising a decision trace structure that represents a decision subset of the plurality of spans that represent decision-making operations performed by the AI agent during execution, an operation trace structure that represents an operation subset of the plurality of spans that represent executive operations performed by the AI agent during execution, and an implementation trace structure that represents an implementation subset of the plurality of spans that represent implementing operations performed by the AI agent during execution; by the trace engine, enrich the hierarchical trace structure with contextual data; generate one or more visual elements based on the enriched hierarchical trace structure; and generate a graphical user interface comprising the one or more visual elements.

Each span in the decision subset of the plurality of spans may be classified into one of a plurality of domains. The plurality of domains may comprise input interpretation, task planning, resource allocation, and goal evaluation.

Each span in the operation subset of the plurality of spans may be classified into one of a plurality of domains. The plurality of domains may comprise tool operations, application programming interface (API) calls, and error handling and recovery.

Each span in the implementation subset of the plurality of spans may be classified into one of a plurality of domains. The plurality of domains may comprise performance metrics, memory management, threading concurrency, and system resources.

The contextual data may comprise a state snapshot of the AI agent at each of one or more points in time during the execution, wherein each state snapshot represents an internal state of the AI agent. Enriching the hierarchical trace structure with contextual data may comprise generating one or more semantics tags for each state snapshot, wherein each state snapshot comprises the one or more semantic tags generated for that state snapshot. The one or more semantic tags may be generated by a Bidirectional Encoder Representations from Transformers (BERT)-based AI model.

The contextual data may comprise a relationship map that represents relationships between operations of the AI agent. The relationships, represented in the relationship map, may comprise temporal relationships, causal relationships, dependency relationships, and semantic relationships. Enriching the hierarchical trace structure with contextual data may comprise generating the relationship map by: deriving a plurality of features from the hierarchical trace structure, wherein the plurality of features comprise one or more temporal features, one or more contextual features, and one or more technical features; applying a plurality of analyses to the plurality of features to identify the relationships between operations of the AI agent; and classifying each of the identified relationships based on type, strength, and impact.

The one or more visual elements may comprise an agent cognitive flow visualizer that comprises an interactive graph representing a hierarchical flow of reasoning by the AI agent, wherein the graph comprises a plurality of nodes and a plurality of directed edges, wherein each of the plurality of nodes represents an operation by the AI agent, and wherein each of the plurality of directed edges connects a pair of the plurality of nodes and represents a causal relationship between the operations represented by that pair of nodes. The plurality of nodes may comprise decision nodes derived from the decision trace structure, operation nodes derived from the operation trace structure, and implementation nodes derived from the implementation trace structure, and wherein the decision nodes are represented in a larger size than the operation nodes and implementation nodes, and the operation nodes are represented in a larger size than the implementation nodes. One or more characteristics of each of the plurality of nodes may be based on one or more parameters of the operation represented by that node, and wherein the one or more characteristics comprises at least one of transparency, color, or size. A thickness of each of the plurality of directed edges may be based on a strength of the causal relationship represented by that directed edge, with a causal relationship having a higher strength represented by a thicker directed edge than a causal relationship with a lower strength.

The one or more visual elements may comprise a state evolution timeline, wherein the state evolution timeline comprises a timeline and a plurality of points, wherein each of the plurality of points represents a state transition and is positioned on the timeline at a location that is representative of a timing of that state transition relative to the state transitions represented by other ones of the plurality of points, and wherein each of one or more of the plurality of points are expandable to reveal a state snapshot of the AI agent at the timing of that point.

It should be understood that any of the features in the methods above may be implemented individually or with any subset of the other features in any combination. Thus, to the extent that the appended claims would suggest particular dependencies between features, disclosed embodiments are not limited to these particular dependencies. Rather, any of the features described herein may be combined with any other feature described herein, or implemented without any one or more other features described herein, in any combination of features whatsoever. In addition, any of the methods, described above and elsewhere herein, may be embodied, individually or in any combination, in executable software modules of a processor-based system, such as a server, and/or in executable instructions stored in a non-transitory computer-readable medium.

### BRIEF DESCRIPTION OF THE DRAWINGS

The details of the present invention, both as to its structure and operation, may be gleaned in part by study of the accompanying drawings, in which like reference numerals refer to like parts, and in which:

FIG. 1 illustrates an example infrastructure, in which one or more of the processes described herein may be implemented, according to an embodiment;

FIG. 2 illustrates an example processing system, by which one or more of the processes described herein may be executed, according to an embodiment;

FIG. 3 illustrates an example process for structured tracing and debugging of AI agents, including visualization, according to an embodiment;

FIG. 4 illustrates an example organization of telemetry data, according to an embodiment;

FIGS. 5A-5D illustrate an example organization of a decision tree structure for various domains, according to an embodiment;

FIGS. 6A-6D illustrate an example organization of an operation tree structure for various domains, according to an embodiment;

FIGS. 7A-7E illustrate an example organization of an implementation tree structure for various domains, according to an embodiment;

FIG. 8 illustrates an example organization of a state snapshot, according to an embodiment; and

FIGS. 9A-9F illustrate examples of visual elements of a visual debugging interface, according to embodiments.

### DETAILED DESCRIPTION

Embodiments of systems, methods, and non-transitory computer-readable media are disclosed for the structured tracing and debugging of AI agents, including visualization. After reading this description, it will become apparent to one skilled in the art how to implement the invention in various alternative embodiments and alternative applications. However, although various embodiments of the present invention will be described herein, it is understood that these embodiments are presented by way of example and illustration only, and not limitation. As such, this detailed description of various embodiments should not be construed to limit the scope or breadth of the present invention as set forth in the appended claims.

### 1. INFRASTRUCTURE

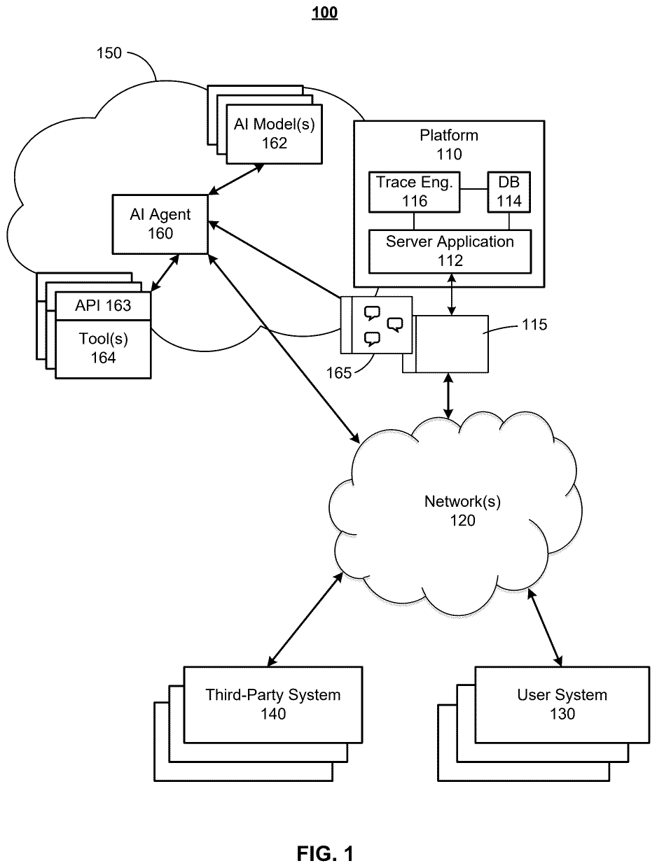

FIG. 1 illustrates an example infrastructure 100, in which one or more of the processes described herein may be implemented, according to an embodiment. Infrastructure 100 may comprise a platform 110 which hosts, supports, and/or executes one or more of the disclosed processes, which may be implemented in software and/or hardware. In particular, platform 110 may execute a server application 112, execute a trace engine 116 that organizes raw trace data into a queryable and hierarchical trace structure for analysis and visualization, and/or host a database 114 that may store data used by server application 112 and/or trace engine 116. Platform 110 may comprise dedicated servers, or may instead be implemented in a computing cloud, in which the resources of one or more servers are dynamically and elastically allocated to multiple tenants based on demand. In either case, the servers may be collocated and/or geographically distributed.

Platform 110 may be communicatively connected to one or more networks 120. Network(s) 120 enable communication between platform 110, one or more user systems 130 and/or third-party systems 140, and/or a computing environment 150 supported by platform 110. Network(s) 120 may comprise the Internet, and communication through network(s) 120 may utilize standard transmission protocols, such as HTTP, HTTP Secure (HTTPS), File Transfer Protocol (FTP), FTP Secure (FTPS), Secure Shell FTP (SFTP), and the like, as well as proprietary protocols. While platform 110 is illustrated as being connected to a plurality of user systems 130 and/or third-party system(s) 140 through a single set of network(s) 120, it should be understood that platform 110 may be connected to different user systems 130 and/or third-party systems 140 via different sets of one or more networks. For example, platform 110 may be connected to a subset of user systems 130 and/or third-party systems 140 via the Internet, but may be connected to another subset of user systems 130 and/or third-party systems 140 via an intranet.

While only a few user systems 130 are illustrated, it should be understood that platform 110 may be communicatively connected to any number of user system(s) 130 via network(s) 120. User system(s) 130 may comprise any type or types of computing devices capable of wired and/or wireless communication, including without limitation, desktop computers, laptop computers, tablet computers, smart phones or other mobile phones, servers, game consoles, televisions, set-top boxes, electronic kiosks, point-of-sale terminals, and/or the like. However, it is generally contemplated that a user system 130 would be the personal computer or professional workstation of a developer, who has a user account for accessing server application 112 on platform 110. Each user account may be associated with an overarching organizational account for managing software entities, including AI agents 160. It should be understood that the user may be anywhere from an expert software engineer, with extensive knowledge of the operation of AI agents 160, to a business decision-maker, lay person, or other non-technical person, with little to no knowledge of the operation of AI agents 160.

Server application 112 may manage computing environment 150. In particular, server application 112 may provide a user interface 115 and backend functionality, including one or more of the processes disclosed herein, to enable or otherwise support users, via user systems 130, to construct, develop, modify, save, delete, test, deploy, un-deploy, and/or otherwise manage software entities within computing environment 150. User interface 115 may comprise a graphical user interface that implements a low-code environment, including potentially a no-code environment, in which users may construct software entities. These software entities may comprise AI agents 160, and potentially other software entities, such as integration processes.

The user of a user system 130 may authenticate with platform 110 using standard authentication means, to access server application 112, via user interface 115, in accordance with roles or permissions of the associated user account. The user may then interact with server application 112 to manage one or more software entities, for example, within a larger software platform within computing environment 150. It should be understood that multiple users, on multiple user systems 130, may manage the same software entities and/or different software entities in this manner, according to the permissions or roles of their associated user accounts.

Of particular relevance to disclosed embodiments, user interface 115 may comprise a graphical user interface, which may include a visual debugging interface that enables users to visualize the structured trace data, generated by trace engine 116. In particular, the graphical user interface may comprise one or more screens (e.g., webpages) that provide access to the structured trace data. For instance, server application 112 may query the structured trace data to generate one or more of visual elements, described elsewhere herein, that represent one or more aspects of the structured trace data, and incorporate the visual element(s) into the one or more screens of the graphical user interface. The screen(s) may comprise one or more inputs, and the one or more of the visual element(s) may be interactive, such that a user can manipulate the visualized trace data using the input(s).

In an embodiment, platform 110 may be an integration platform as a service (iPaaS) platform. In this case, the software entities(s) being developed may include integration process(es). Computing environment 150 may comprise one or a plurality of integration platforms that each comprises one or a plurality of integration processes. Each integration platform may be associated with an organization, which may be associated with one or more user accounts by which respective user(s) manage the organization's integration platform, including the various integration process (cs). An integration process may represent a transaction involving the integration of data between two or more systems, and may comprise a series of elements that specify logic and transformation requirements for the data to be integrated. Each element, which may also be referred to as a “step,” may transform, route, and/or otherwise manipulate data to attain an end result from input data. For example, a basic integration process may receive data from one or more data sources (e.g., via an application programming interface of the integration process), manipulate the received data in a specified manner (e.g., including mapping, analyzing, normalizing, altering, updating, enhancing, and/or augmenting the received data), and send the manipulated data to one or more specified destinations (e.g., via an application programming interface of each destination). An integration process may represent a business workflow or a portion of a business workflow or a transaction-level interface between two systems, and comprise, as one or more elements, software modules that process data to implement the business workflow or interface. A business workflow may comprise any myriad of workflows of which an organization may repetitively have need. For example, a business workflow may comprise, without limitation, procurement of parts or materials, manufacturing a product, selling a product, shipping a product, ordering a product, billing, managing inventory or assets, providing customer service, ensuring information security, marketing, onboarding or offboarding an employee, assessing risk, obtaining regulatory approval, reconciling data, auditing data, providing information technology services, and/or any other workflow that an organization may implement in software. These integration processes, and/or the development and/or management of these integration processes, may be supported by one or more AI agents 160, and/or the integration processes may support AI agents 160, for example, as tools 164 that are utilized by AI agents 160.

Each integration process, when deployed, may be communicatively coupled to network(s) 120. For example, each integration process may comprise an application programming interface that enables clients to access an integration process via network(s) 120. A client may push data to an integration process through application programming interface, and/or pull data from an integration process through the application programming interface.

One or more third-party systems 140 may be communicatively connected to network(s) 120, such that each third-party system 140 may communicate with an AI agent 160 and/or integration process in computing environment 150 via an application programming interface. Third-party system 140 may host and/or execute a software application that pushes data to an AI agent 160 and/or integration process and/or pulls data from an AI agent 160 and/or integration process, via the application programming interface of the AI agent 160 or integration process. Additionally or alternatively, an AI agent 160 and/or integration process may push data to a software application on third-party system 140 and/or pull data from a software application on third-party system 140, via an application programming interface of the third-party system 140. Thus, third-party system 140 may be a client or consumer of one or more AI agents 160 and/or integration processes, a data source for one or more AI agents 160 and/or integration processes, and/or the like. As examples, the software application on third-party system 140 may comprise, without limitation, enterprise resource planning (ERP) software, customer relationship management (CRM) software, accounting software, and/or the like.

In an embodiment, the software entities(s) being developed and/or otherwise managed on platform 110 include AI agents 160. An AI agent 160 is any software entity that utilizes artificial intelligence (e.g., machine learning, natural-language processing, data analytics, etc.), embodied in one or more AI models 162, to autonomously perform a task, in order to achieve an objective set by a human, other software entity, or other system. AI agent 160 may collect data, analyze data, communicate with human users and/or other software entities, collaborate with other AI agents 160 to complete a complex task, execute actions, learn and improve over time, and/or the like.

Each AI agent 160 comprises or is communicatively coupled to at least one AI model 162. AI model 162 may be internal to AI agent 160, external but local (i.e., within computing environment 150) to AI agent 160, or external and remote (i.e., outside computing environment 150, e.g., hosted on third-party system 140, etc.) from AI agent 160. An AI model 162 may be a generative AI model, such as a generative language model (e.g., small language model, large language model, etc., that responds to natural-language prompts in natural language), generative image model (e.g., that responds to natural-language prompts with an image), generative video model (e.g., that responds to natural-language prompts with a video), generative coding model (e.g., that responds to natural-language prompts with software code), or the like. As used herein, the term “natural language” or “natural-language” refers to language, including grammar, that would be expected in a normal conversation between two humans. A pre-trained generative AI model may be used as a base model that is fine-tuned for the specific task of AI agent 160, to produce AI model 162.

One well-known example of a large language model is the Generative Pre-trained Transformer (GPT). GPT-4 is the fourth-generation language prediction model in the GPT-n series, created by OpenAI of San Francisco, California. GPT-4 is an autoregressive language model that uses deep learning to produce human-like text. GPT-4 has been pre-trained on a vast amount of text from the open Internet. While GPT-4 is provided as an example, it should be understood that the generative language model may be any generative language model, including past and future generations of GPT, as well as other large language models, such as any of the DeepSeek family of large language models from DeepSeck AI of Hangzhou, Zhejiang, China, any of the Claude family of large language models (e.g., Claude Opus, Claude Sonnet, etc.) developed by Anthropic PBC of San Francisco, California, the Falcon large language model (e.g., Falcon 160B) released by the United Arab Emirates' Technology Innovation Institute (TII), the Large Language Model Meta AI (LLaMA) model (e.g., LLaMA 2) released by Meta AI of New York, New York, any of the Gemini family of large language models from Google LLC of Mountain View, California, any of the Mistral family of models released by Mistral AI of Paris, France, and the like.

Examples of generative image models include, without limitation, the DALL-E family of models (e.g., DALL-E, DALL-E 2, or DALL-E 3) from OpenAI, Stable Diffusion (e.g., SD 3.5) from Stability AI Ltd of London, England, United Kingdom, Imagen (e.g., Imagen 3) from Google LLC of Mountain View, California, Midjourney form Midjourney, Inc. of San Francisco, California, Adobe Firefly from Adobe Inc. of San Jose, California, Picasso from Nvidia Corp. of Santa Clara, California, Runway Gen-2 from Runway AI, Inc. of New York City, New York, and the like. Examples of generative video models include, without limitation, Runway Gen-2, the Pika family of models from Pika Labs AI of San Francisco, California, Lumiere from Google LLC, VideoLDM from Nvidia, Make-A-Video from Meta Platforms, Inc. of Menlo Park, California, Synthesia from Synthesia of London, England, United Kingdom, DeepBrain AI from AI Studios of Palo Alto, California, Stable Video Diffusion from Stability AI Ltd, and the like.

Examples of generative coding models include, without limitation, Codex from OpenAI, AlphaCode from Google LLC, Code LLaMA from Meta AI, AlphaFold Code from DeepMind Technologies Limited of London, England, United Kingdom, CodeWhisperer from Amazon Web Services of Seattle, Washington, CodeGen from Salesforce, Inc. of San Francisco, California, StarCoder developed by Hugging Face and ServiceNow Research, Tabnine from Tabnine of Tel Aviv, Israel, and the like.

In furtherance of its respective task, AI agent 160 may generate an input to AI model 162 based on any of the data utilized by AI agent 160. In particular, AI agent 160 may incorporate relevant data into a predefined template to generate a prompt, which may comprise or consist of a natural-language expression. The predefined template may comprise a pre-conversation and/or post-conversation, which provide context and/or instructions for AI model 162, and one or more placeholders into which the relevant data are inserted. The pre-conversation and/or post-conversation may define the role of AI model 162 model (e.g., to respond to a query, request, or other input according to the relevant data and a current context, summarize the relevant data, generate image or video data or software code from the relevant data, perform an action, etc.), define an output format for AI model 162 (e.g., natural language, a table, a list structure, a hierarchical structure, a markup-language structure, etc.), and/or the like. The prompt is input to AI model 162 to produce a response from AI model 162 (e.g., in the output format defined by the prompt).

Each AI agent 160 may comprise or be communicatively coupled to zero, one, or a plurality of tools 164. Tool(s) 164 may be hosted within computing environment 150 (e.g., a cloud-computing environment) and/or externally to computing environment 150 (e.g., on a third-party system 140). AI agent 160 may communicate with a tool 164 via an application programming interface 163 of that tool 164. Application programming interface 163 may provide one or more operations that can be performed by AI agent 160 using the respective tool 164. Each operation may accept zero, one, or a plurality of parameters as input and/or return an output that comprises data representing a response, an acknowledgement, and/or the like. An operation, which may also be referred to as an “endpoint,” may be defined by a base Uniform Resource Locator (URL), a path that indicates the resource or action being requested, an HTTP method defining the action to be performed (e.g., GET, POST, PUT, DELETE, etc.), zero, one, or more request parameters, a response format, an authentication or security protocol, a version number, rate limits, error handling, and/or the like.

Tools 164 enable an AI agent 160 to interact with external systems, and even potentially, the physical world. Each tool 164 may perform a task for the overall objective of AI application 160. A task may comprise retrieving data from a source (e.g., another software entity, a local database hosted within computing environment 150, a remote database hosted externally to computing environment 150, a third-party system, application, or database, an integration process, a knowledge base, etc.), transforming, formatting, mapping, cleaning, or otherwise manipulating data, analyzing data, storing data, sending data (e.g., tabular or other structured data, unstructured data, commands, requests, queries, etc.) to a destination (e.g., another software entity, a local database, a remote database, a third-party system, application, or database, an integration process, knowledge base, etc.), initiating a transaction (e.g., purchase, sale, exchange, trade, etc.), completing a transaction, actuating a physical device (e.g., activate a motor, switch, or other machine component, set or adjust a setpoint for a control parameter, etc.), and/or the like.

In some cases, an AI agent 160 may be an AI chat agent. In this case, AI agent 160 may implement a chat interface 165. Chat interface 165 may be comprised or embedded (e.g., as an overlaid chat frame) within user interface 115. Alternatively, chat interface 165 may be separate and distinct from user interface 115. Chat interface 165 may comprise a graphical user interface, an audio interface, or a combination of graphical and audio user interface (i.e., an audiovisual interface).

### 2. EXAMPLE PROCESSING SYSTEM

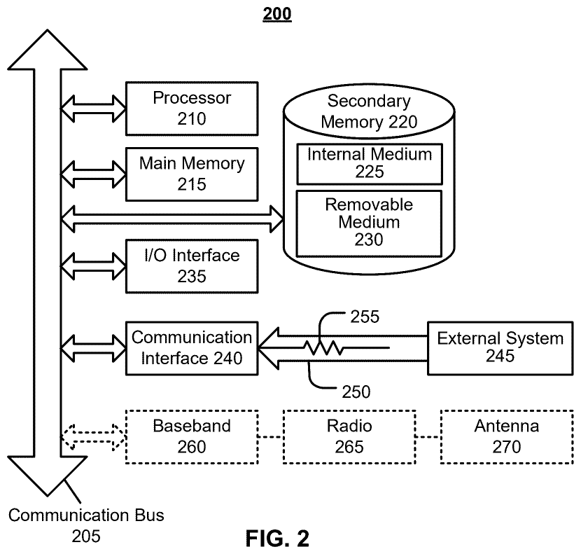

FIG. 2 illustrates an example processing system 200, by which one or more of the processes described herein may be executed, according to an embodiment. For example, system 200 may be used to store and/or execute server application 112, trace engine 116, AI agent 160, AI model(s) 162, tool(s) 164, and/or may represent components of platform 110, user system(s) 130, third-party system(s) 140, and/or other processing devices described or implied herein. System 200 can be any processor-enabled device (e.g., server, personal computer, etc.) that is capable of wired or wireless data communication. Other processing systems and/or architectures may also be used, as will be clear to those skilled in the art.

System 200 may comprise one or more processors 210. Processor(s) 210 may comprise a central processing unit (CPU). Additional processors may be provided, such as a graphics processing unit (GPU), an auxiliary processor to manage input/output, an auxiliary processor to perform floating-point mathematical operations, a special-purpose microprocessor having an architecture suitable for fast execution of signal-processing algorithms (e.g., digital-signal processor), a subordinate processor (e.g., back-end processor), an additional microprocessor or controller for dual or multiple processor systems, and/or a coprocessor. Such auxiliary processors may be discrete processors or may be integrated with a main processor 210. Examples of processors which may be used with system 200 include, without limitation, any of the processors (e.g., Pentium™, Core i7™, Core i9™, Xeon™, etc.) available from Intel Corporation of Santa Clara, California, any of the processors available from Advanced Micro Devices, Incorporated (AMD) of Santa Clara, California, any of the processors (e.g., A series, M series, etc.) available from Apple Inc. of Cupertino, any of the processors (e.g., Exynos™) available from Samsung Electronics Co., Ltd., of Seoul, South Korea, any of the processors available from NXP Semiconductors N.V. of Eindhoven, Netherlands, any of the processors available from Nvidia Corporation of Santa Clara, California, and/or the like.

Processor(s) 210 may be connected to a communication bus 205. Communication bus 205 may include a data channel for facilitating information transfer between storage and other peripheral components of system 200. Furthermore, communication bus 205 may provide a set of signals used for communication with processor 210, including a data bus, address bus, and/or control bus (not shown). Communication bus 205 may comprise any standard or non-standard bus architecture such as, for example, bus architectures compliant with industry standard architecture (ISA), extended industry standard architecture (EISA), Micro Channel Architecture (MCA), peripheral component interconnect (PCI) local bus, standards promulgated by the Institute of Electrical and Electronics Engineers (IEEE) including IEEE 488 general-purpose interface bus (GPIB), IEEE 696/S-100, and/or the like.

System 200 may comprise main memory 215. Main memory 215 provides storage of instructions and data for programs executing on processor 210, such as any of the software discussed herein. It should be understood that programs stored in the memory and executed by processor 210 may be written and/or compiled according to any suitable language, including without limitation C/C++, Java, JavaScript, Perl, Python, Visual Basic, .NET, and the like. Main memory 215 is typically semiconductor-based memory such as dynamic random access memory (DRAM) and/or static random access memory (SRAM). Other semiconductor-based memory types include, for example, synchronous dynamic random access memory (SDRAM), Rambus dynamic random access memory (RDRAM), ferroelectric random access memory (FRAM), and the like, including read only memory (ROM).

System 200 may comprise secondary memory 220. Secondary memory 220 is a non-transitory computer-readable medium having computer-executable code and/or other data (e.g., any of the software disclosed herein) stored thereon. In this description, the term “computer-readable medium” is used to refer to any non-transitory computer-readable storage media used to provide computer-executable code and/or other data to or within system 200. The computer software stored on secondary memory 220 is read into main memory 215 for execution by processor 210. Secondary memory 220 may include, for example, semiconductor-based memory, such as programmable read-only memory (PROM), erasable programmable read-only memory (EPROM), electrically erasable read-only memory (EEPROM), and flash memory (block-oriented memory similar to EEPROM).

Secondary memory 220 may include an internal medium 225 and/or a removable medium 230. Internal medium 225 and removable medium 230 are read from and/or written to in any well-known manner. Internal medium 225 may comprise one or more hard disk drives, solid state drives, and/or the like. Removable storage medium 230 may be, for example, a magnetic tape drive, a compact disc (CD) drive, a digital versatile disc (DVD) drive, other optical drive, a flash memory drive, and/or the like.

System 200 may comprise an input/output (I/O) interface 235. I/O interface 235 provides an interface between one or more components of system 200 and one or more input and/or output devices. Examples of input devices include, without limitation, sensors, keyboards, touch screens or other touch-sensitive devices, cameras, biometric sensing devices, computer mice, trackballs, pen-based pointing devices, and/or the like. Examples of output devices include, without limitation, other processing systems, cathode ray tubes (CRTs), plasma displays, light-emitting diode (LED) displays, liquid crystal displays (LCDs), printers, vacuum fluorescent displays (VFDs), surface-conduction electron-emitter displays (SEDs), field emission displays (FEDs), and/or the like. In some cases, an input and output device may be combined, such as in the case of a touch-panel display (e.g., in a smartphone, tablet computer, or other mobile device).

System 200 may comprise a communication interface 240. Communication interface 240 allows software to be transferred between system 200 and external devices, networks, or other information sources. For example, computer-executable code and/or data may be transferred to system 200 from a network server via communication interface 240. Examples of communication interface 240 include a built-in network adapter, network interface card (NIC), Personal Computer Memory Card International Association (PCMCIA) network card, card bus network adapter, wireless network adapter, Universal Serial Bus (USB) network adapter, modem, a wireless data card, a communications port, an infrared interface, an IEEE 1394 fire-wire, and any other device capable of interfacing system 200 with a network (e.g., network(s) 120) or another computing device. Communication interface 240 preferably implements industry-promulgated protocol standards, such as Ethernet IEEE 802 standards, Fiber Channel, digital subscriber line (DSL), asynchronous digital subscriber line (ADSL), frame relay, asynchronous transfer mode (ATM), integrated digital services network (ISDN), personal communications services (PCS), transmission control protocol/Internet protocol (TCP/IP), serial line Internet protocol/point to point protocol (SLIP/PPP), and so on, but may also implement customized or non-standard interface protocols as well.

Software transferred via communication interface 240 is generally in the form of electrical communication signals 255. These signals 255 may be provided to communication interface 240 via a communication channel 250 between communication interface 240 and an external system 245. In an embodiment, communication channel 250 may be a wired or wireless network (e.g., network(s) 120), or any variety of other communication links. Communication channel 250 carries signals 255 and can be implemented using a variety of wired or wireless communication means including wire or cable, fiber optics, conventional phone line, cellular phone link, wireless data communication link, radio frequency (“RF”) link, or infrared link, just to name a few.

Computer-executable code is stored in main memory 215 and/or secondary memory 220. Computer-executable code can also be received from an external system 245 via communication interface 240 and stored in main memory 215 and/or secondary memory 220. Such computer-executable code, when executed, enables system 200 to perform one or more of the various processes disclosed herein.

In an embodiment that is implemented using software, the software may be stored on a computer-readable medium and initially loaded into system 200 by way of removable medium 230, I/O interface 235, or communication interface 240. In such an embodiment, the software is loaded into system 200 in the form of electrical communication signals 255. The software, when executed by processor 210, may cause processor 210 to perform one or more of the various processes disclosed herein.

System 200 may optionally comprise wireless communication components that facilitate wireless communication over a voice network and/or a data network (e.g., in the case of user system 130). The wireless communication components comprise an antenna system 270, a radio system 265, and a baseband system 260. In system 200, radio frequency (RF) signals are transmitted and received over the air by antenna system 270 under the management of radio system 265.

In an embodiment, antenna system 270 may comprise one or more antennae and one or more multiplexors (not shown) that perform a switching function to provide antenna system 270 with transmit and receive signal paths. In the receive path, received RF signals can be coupled from a multiplexor to a low noise amplifier (not shown) that amplifies the received RF signal and sends the amplified signal to radio system 265.

In an alternative embodiment, radio system 265 may comprise one or more radios that are configured to communicate over various frequencies. In an embodiment, radio system 265 may combine a demodulator (not shown) and modulator (not shown) in one integrated circuit (IC). The demodulator and modulator can also be separate components. In the incoming path, the demodulator strips away the RF carrier signal leaving a baseband receive audio signal, which is sent from radio system 265 to baseband system 260.

If the received signal contains audio information, baseband system 260 decodes the signal and converts it to an analog signal. Then, the signal is amplified and sent to a speaker. Baseband system 260 also receives analog audio signals from a microphone. These analog audio signals are converted to digital signals and encoded by baseband system 260. Baseband system 260 also encodes the digital signals for transmission and generates a baseband transmit audio signal that is routed to the modulator portion of radio system 265. The modulator mixes the baseband transmit audio signal with an RF carrier signal, generating an RF transmit signal that is routed to antenna system 270 and may pass through a power amplifier (not shown). The power amplifier amplifies the RF transmit signal and routes it to antenna system 270, where the signal is switched to the antenna port for transmission.

Baseband system 260 may be communicatively coupled with processor(s) 210, which have access to memory 215 and 220. Thus, software can be received from baseband processor 260 and stored in main memory 210 or in secondary memory 220, or executed upon receipt. Such software, when executed, can enable system 200 to perform one or more of the various processes disclosed herein.

### 3. INTRODUCTION

Disclosed embodiments aid in the debugging of AI agents 160. While embodiments will aid in the debugging any type of AI agent 160, embodiments may be particularly useful for AI agents 160 that are reasoning agents. Generally, the operation of a reasoning AI agent 160 will have three phases: planning, execution, and evaluation. In the planning phase, AI agent 160 analyzes the current input, state of AI agent 160, and objective, breaks down the objective into manageable sub-tasks, develops a strategy based on all available knowledge and considering any applicable constraints and the available resources, and creates a plan comprising an executable sequence of actions. In the execution phase, AI agent 160 implements the plan, which includes interactions with its environment (e.g., one or more AI models 162, allocated memory and/or data storage, etc.) and/or other systems (e.g., one or more tools 164), handles any errors, updates the state of AI agent 160, and records all performed actions and their outcomes. In the evaluation phase, AI agent 160 assesses the outcomes against intended goals, identifies successes and failures, generates knowledge, updates the state and knowledge of AI agent 160, refines decisions, and learns for improved future planning.

During operation of AI agent 160, an observability framework may be used to generate and manage telemetry data for AI agent 160. One example of an observability framework is OpenTelemetry (OTel), which is an open-source observability framework, managed by the Cloud Native Computing Foundation (CNCF). OTel and other observability frameworks provide a standardized means for capturing, processing, and exporting monitored telemetry data across distributed systems. Advantageously, OTel is vendor-neutral and has a pluggable architecture that supports multiple backends through different exporters.

Telemetry data for AI agent 160 may comprise traces, metrics, logs, and/or the like. A trace represents the complete path of a request across system components (e.g., AI model(s) 162, tool(s) 164, etc.), and tracks the flow of requests across distributed system components, including the timing of operations and the relationships between operations. A metric may provide quantitative measurements of AI agent 160 (e.g., measuring the performance of AI agent 160). A log may comprise discrete events that occur during execution of AI agent 160, potentially with detailed context.

A trace comprises or consists of one or more spans. Each span represents a unit of work or operation. Spans may have hierarchical parent-child relationships to each other, such that a first span may be a parent to a second span, in which case the second span is a child to the first span. It should be understood that any number of hierarchical levels may be formed in this manner, since a child span may be the child of another child span, which may be the child of another child span, and so on and so forth. These parent-child relationships represent how operations are nested and connected to each other. A span may comprise a name of the operation, a type of the operation, a timestamp of the operation, a time duration of the operation, a reference to a parent span (if any), the value of each of one or more attributes that describe the operation, one or more events marking significant points in the operation (if any), links to related spans (if any), and/or the like.

The OTel framework comprises an instrumentation layer and an export layer. The instrumentation layer adds software code to computing environment 150 to monitor (e.g., measure, track, etc.) the performance and behavior of AI agent(s) 160. The software code or “instrumentation” may be added within each AI agent 160, like a sensor, to monitor operations within AI agent 160 and generate the telemetry data. This instrumentation may be performed automatically (e.g., using a library of the observability framework) and/or manually (e.g., using software code). The export layer receives the telemetry data, generated by the instrumentation layer, and exports the telemetry data to one or more backend systems.

The export layer may comprise one or more exporters. An exporter is configured to send the telemetry data to one or more collectors, for example, using the OTel protocol (OTLP). For instance, an exporter within computing environment 150 may export the telemetry data for AI agent 160 to a collector. Examples of OTel-compatible exporters include, without limitation, Elasticsearch™ developed by Elastic N.V. of Amsterdam, Netherlands, Jaeger™ maintained by the CNCF, Zipkin™ maintained by the OpenZipkin project, Prometheus™ maintained by the CNCF, and the like.

A collector receives and stores the telemetry data, exported by one or more exporters. For example, a collector may be comprised in server application 112, and store the received telemetry data in database 114, for processing by trace engine 116. Notably, the collector may be configured with different exporters, without requiring changes to the instrumentation (i.e., software code) that is added to AI agents 160. In an embodiment, the collector is a component of trace engine 116. Alternatively, the collector may be separate from trace engine 116 and store at least a portion of the telemetry data (e.g., traces) in database 114, such that trace engine 116 can access that telemetry data from database 114. In any case, the collector may collect the telemetry data in real time, as AI agent 160 is executing. As used herein, the terms “real time” and “real-time” refer to events that occur simultaneously with each other, as well as events that are temporally separated from each other by ordinary delays caused, for example, by latencies in processing, communications, memory access, and/or the like, including events that are sometimes referred to as near-real-time events.

Disclosed embodiments capture, structure, and visualize the execution paths of AI agents 160, via a trace engine 116 and user interface 115. To structure the execution paths, trace engine 116 may employ a hierarchical tracing mechanism that converts traces of AI agents 160 into queryable structures. These queryable structures may then support an interactive visual debugging interface provided by user interface 115, which significantly improves transparency, debuggability, explainability, and reliability of AI agents 160 in computing environment 150 (e.g., an enterprise environment, integration environment, etc.).

In an embodiment, trace engine 116 implements a hierarchical tracing architecture that captures data in the trace of AI agent 160 at a plurality of levels. The plurality of levels may comprise, in order from highest level to lowest level, a decision level, an operation level, and an implementation level. This three-level hierarchy of high-level decisions, mid-level operations, and low-level implementations mirrors how AI agents 160 make decisions and execute tasks to achieve an objective. At the highest level, the decision layer captures strategic decision-making and planning performed by AI agent 160, including the initial analysis of an input to AI agent 160, goal setting, and high-level strategy formation. In the middle level, the operation layer handles the coordination and management of specific tasks, serving as a bridge between strategic decisions and concrete actions. At the lowest level, the implementation layer records the actual execution details, including API calls, resource usage, and specific outcomes.

Trace engine 116 may remain agnostic to the underlying storage system through an abstraction layer. As an example, Elasticsearch™, which is a Representational State Transfer (REST)-ful search and analytics engine built on Apache Lucene, natively supports the hierarchical document structure of OTel traces, and the JSON-based document model directly maps to the span structure in the traces. Trace engine 116 may export data using the OTLP format, which can be consumed by any OTel-compatible collector.

### 4. OVERALL PROCESS

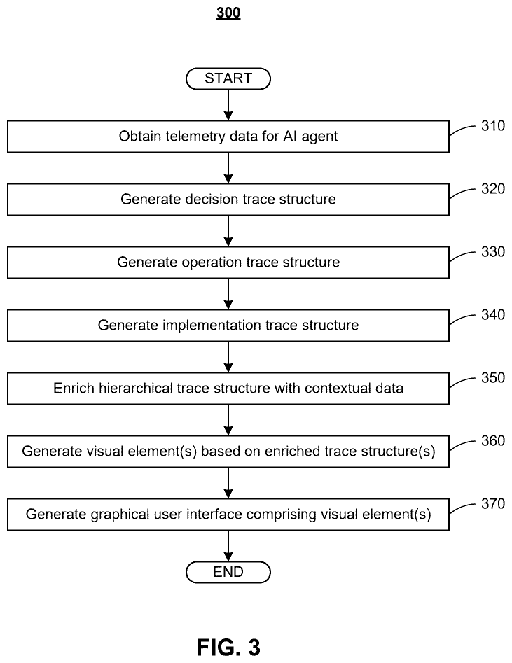

FIG. 3 illustrates an example process 300 for structured tracing and debugging of AI agents, including visualization, according to an embodiment. Process 300 may be implemented by server application 112, user interface 115, and/or trace engine 116. In particular, certain subprocesses (e.g., 310-350) may be performed by trace engine 116, while other subprocesses (e.g., 360 and 370) may be performed by server application 112 and/or the visual debugging interface of user interface 115. Process 300 may be performed for each of one or more, and generally a plurality of, AI agents 160, executing within computing environment 150.

While process 300 is illustrated with a certain arrangement and ordering of subprocesses, process 300 may be implemented with fewer, more, or different subprocesses and a different arrangement and/or ordering of subprocesses. Furthermore, any subprocess, which does not depend on the completion of another subprocess, may be executed before, after, or in parallel with that other independent subprocess, even if the subprocesses are described or illustrated in a particular order.

Subprocess 310 may obtain telemetry data for AI agent 160, executing in computing environment 150. The telemetry data may comprise a trace for AI agent 160. The trace may comprise a plurality of spans that represent operations performed by AI agent 160 during execution. It should be understood that the telemetry data may comprise additional data, such as one or more metrics, a log, and/or the like. Subprocess 310 may be performed by trace engine 116 on telemetry data that are collected by a collector of trace engine 116 or by a separate collector (e.g., implemented within server application 112).

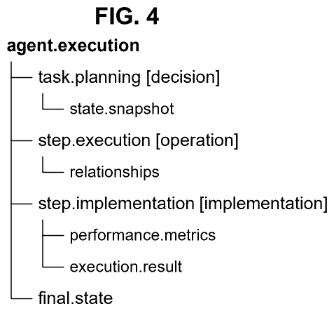

FIG. 4 illustrates an example organization of the telemetry data that may be obtained in subprocess 310, according to an embodiment. In this case, the telemetry data, represented by agent.execution, comprises task-planning data (“task.planning”) representing the decision layer of AI agent 160, execution data (“step.execution”) representing the operation layer of AI agent 160, implementation data (“step.implementation”) representing the implementation layer of AI agent 160, and a final state (“final.state”) of AI agent 160. In addition, the task-planning data may be hierarchically associated with a snapshot (“state.snapshot”) of the state of AI agent 160 during task planning, the execution data may be hierarchically associated with relationships (“relationships”) between operations performed by AI agent 160, and the implementation data may be hierarchically associated with performance metrics (“performance.metrics”) and the execution result (“execution.result”) of AI agent 160.

Subprocesses 320, 330, and 340 separate the raw trace data in the telemetry data into a queryable hierarchical data structure that comprises spans categorized into a plurality of different levels. In the illustrated embodiment, the plurality of levels comprise or consist of a decision level, an operation level, and an implementation level.

The classification of spans into their respective levels may be performed by a random forest algorithm, deep-learning neural network (DNN), support vector machine (SVM), or other algorithm. For instance, a machine-learning model may be trained, via supervised learning, using a training dataset comprising a plurality of training records that each includes a feature vector, comprising features extracted from a span, labeled with a target representing the ground-truth classification from among a plurality of classifications representing the plurality of levels (e.g., decision, operation, or implementation level). The machine-learning model may be trained by inputting the training records into the machine-learning model, and adjusting weights within the machine-learning model to minimize the error between the classifications, output by the machine-learning model, and the respective ground-truth classifications for the training records. Once trained, the same features, as used in the training records, may be extracted from each span in the raw trace data, and the machine-learning model may be applied to the extracted features for each span to output a classification for that span. In this manner, each span in the raw trace data may be classified into one of the plurality of levels.

Subprocess 320, which may be implemented by trace engine 116, may generate a decision trace structure based on the trace in the telemetry data, obtained in subprocess 310. The decision trace structure may represent a decision subset of the plurality of spans, in the trace, that represent decision-making operations performed by AI agent 160 during execution. In other words, the decision trace structure may comprise the spans that have been classified as decision-level.

In an embodiment, the decision trace structure is organized into domains that capture different aspects of the decision-making process by AI agent 160. In particular, each of the spans in the decision subset may be classified into one of these domains. For example, the domains at the decision level may comprise input interpretation, task planning, resource allocation, and goal evaluation and/or adjustment. Thus, the decision subset of spans may include operations that represent one of these domains.

The domain of input interpretation focuses on understanding incoming inputs (e.g., requests, queries, etc.) to AI agent 160, within the context of AI agent 160. Generally, input interpretation in AI agent 160 begins with a semantic analysis of the input to detect intent within the relevant context. This sets the foundation for the decision-making of AI agent 160 by ensuring that AI agent 160 fully understands the task requirements and operating environment. Input interpretation typically culminates in a decision outcome that includes a selected path, a confidence score for the selection of the path, alternative paths, and a detailed rationale for the selection of the path over the alternative paths.

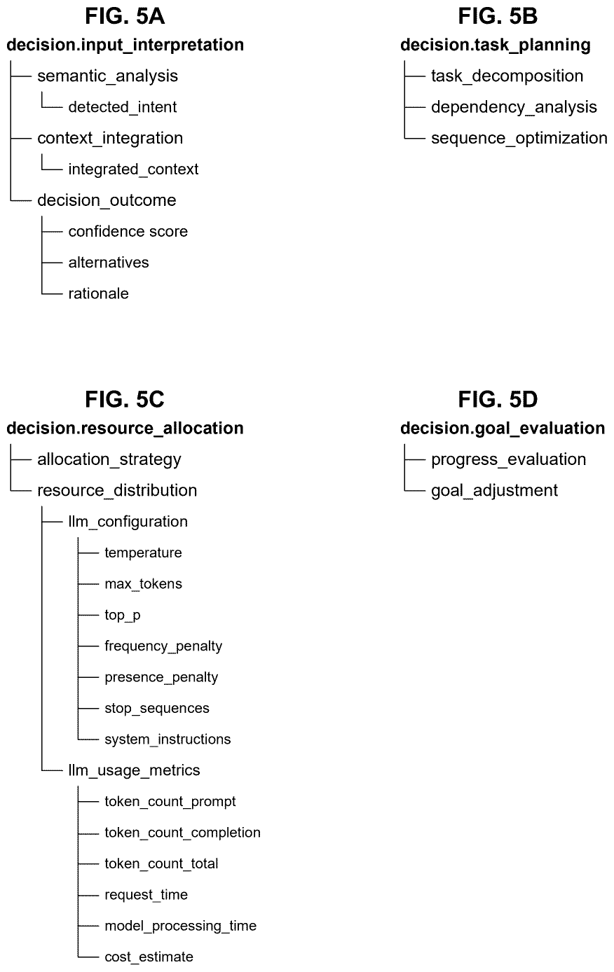

FIG. 5A illustrates an example organization of the decision trace structure for the domain of input interpretation, according to an embodiment. In particular, the domain of input interpretation may comprise a semantic analysis (“semantic_analysis”) that determines the intent of the input, context integration (“context_integration”) which integrates context into the input, and a decision outcome (“decision_outcome”) that reflects the path selected by AI agent 160. The semantic analysis may include the detected intent (“detected_intent”). The context integration may include the integrated context. The decision outcome may include a confidence score for the path that was selected, the confidence score for the selection, one or more alternatives to the selected path, and a rationale for the selection.

The domain of task planning represents the phase in which complex tasks are broken down into manageable sub-tasks. AI agent 160 analyzes dependencies between these sub-tasks and optimizes the sequence in which the sub-tasks are executed.

FIG. 5B illustrates an example organization of the decision trace structure for the domain of task planning, according to an embodiment. In particular, the domain of task planning may comprise task decomposition (“task_decomposition”) which decomposes the overall task into a plurality of sub-tasks, dependency analysis (“dependency_analysis) which identifies any dependencies between the sub-tasks, and sequence optimization (“sequence_optimization”) which determines an optimal sequence in which the sub-tasks should be executed based on the identified dependencies.

The domain of resource allocation determines the best strategy for distributing resources, available to AI agent 160, across the sequence of sub-tasks output by the task planning. For example, resource allocation may allocate one or more available computational resources (e.g., processing units, memory, data storage, network bandwidth, etc.) to the sub-tasks, which may comprise queries to an AI model 162, one or more tools 164, or the like.

FIG. 5C illustrates an example organization of the decision trace structure for the domain of resource allocation, according to an embodiment. In particular, the domain of resource allocation may comprise a strategy (“allocation_strategy”) for allocating computational resources to the sub-tasks, and a resource distribution (“resource_distribution”) of the computational resources to the sub-tasks. The resource distribution may include a model configuration (“llm_configuration”) of AI model 162 (e.g., a large language model), and usage metrics (“llm_usage_metrics”) for AI model 162. In an embodiment in which AI model 162 is a large language model, the model configuration may include a temperature (“temperature”), a maximum number of tokens (“max_tokens”), a Top-p value (“top_p”), a frequency penalty (“frequency_penalty”), a presence penalty (“presence penalty”), one or more stop sequences (“stop_sequences”), and one or more system instructions (“system_instructions”) for AI model 162. The usage metrics may include the number of tokens in the prompt (“token_count_prompt”) to AI model 162, the number of tokens in the response (“token_count_completion”) from AI model 162, a total number of tokens (“token_count_total”), a request time (“request_time”), the computational time taken by AI model 162 (“model_processing_time”), and a cost estimate (“cost_estimate”) for executing AI model 162.

The domain of goal evaluation provides metrics and insights to be used to adjust future goals. These adjustments create a feedback loop that maintains alignment between the actual and desired outcomes of AI agent 160.

FIG. 5D illustrates an example organization of the decision trace structure for the domain of goal evaluation, according to an embodiment. In particular, the domain of goal evaluation may comprise an evaluation of the progress of AI agent 160 (“evaluation_progress”), and an adjustment of the goal of AI agent 160 (“goal_adjustment”).

A concrete, non-limiting, and illustrative example of a decision trace structure is provided below:

```
{
  “traceID”: “agent_exec_123”,
  “spans”: [
    {
      “spanID”: “decision_span_1”,
      “parentSpanID”: null, // Root decision span
      “operationName”: “agent.decision.task_planning”,
      “startTime”: “2023-01-01T00:00:00Z”,
      “duration”: 100000,
      “tags”: {
        “decision.stage”: “TASK_PLANNING”,
        “decision.input”: “analyze_financial_report”,
        “decision.confidence”: 0.92,
        “state.snapshot”: {
          “context”: “financial_analysis”,
          “available_tools”: [“pdf_reader”, “data_analyzer”, “summarizer”]
        }
      }
    },
    {
      “spanID”: “decision_span_2”,
      “parentSpanID”: “decision_span_1”,
      “operationName”: “agent.decision.resource_allocation”,
      “startTime”: “2023-01-01T00:00:00.005Z”,
      “duration”: 35000,
      “tags”: {
        “decision.stage”: “RESOURCE_ALLOCATION”,
        “allocation_strategy”: {
          “strategy_name”: “priority_based”,
          “priority_level”: “high”
        },
        “resource_distribution”: {
          “llm_configuration”: {
            “model”: “gpt-4”,
            “temperature”: 0.2,
            “max_tokens”: 1500,
            “top_p”: 0.95,
            “frequency_penalty”: 0.0,
            “presence_penalty”: 0.0,
            “stop_sequences”: [“END_ANALYSIS”],
            “system_instructions”: “Analyze financial reports with attention
to quarterly trends and anomalies.”
          },
          “llm_usage_metrics”: {
            “token_count_prompt”: 1240,
            “token_count_completion”: 845,
            “token_count_total”: 2085,
            “request_time”: “1200ms”,
            “model_processing_time”: “950ms”,
            “cost_estimate”: “\$0.042”
          }
        }
      }
    },
    {
      “spanID”: “operational_span_1”,
      “parentSpanID”: “decision_span_1”, // Child of planning decision
      “operationName”: “agent.operational.tool_selection”,
      “startTime”: “2023-01-01T00:00:00.010Z”,
      “duration”: 50000,
      “tags”: {
        “selected_tool”: “pdf_reader”,
        “tool.purpose”: “document_extraction”,
        “tool.parameters”: {
          “format”: “financial_statement”,
          “extraction_mode”: “structured”
        },
        “relationship.type”: “tool_execution”
      }
    },
    {
      “spanID”: “implementation_span_1”,
      “parentSpanID”: “operational_span_1”, // Child of tool selection
      “operationName”: “agent.implementation.pdf_extraction”,
      “startTime”: “2023-01-01T00:00:00.015Z”,
      “duration”: 30000,
      “tags”: {
        “execution.status”: “success”,
        “performance.metrics”: {
          “memory_usage”: “256MB”,
          “processing_time”: “28ms”
        },
        “extraction.results”: {
          “pages_processed”: 5,
          “data_extracted”: “financial_tables”
        }
      }
    },
    {
      “spanID”: “operational_span_2”,
      “parentSpanID”: “decision_span_2”, // Child of resource allocation
      “operationName”: “agent.operational.api_calls”,
      “startTime”: “2023-01-01T00:00:00.040Z”,
      “duration”: 1200,
      “tags”: {
        “api.provider”: “OpenAI”,
        “api.endpoint”: “/v1/chat/completions”,
        “api.purpose”: “financial_analysis”,
        “request.parameters”: {
          “model”: “gpt-4”,
          “temperature”: 0.2,
          “max_tokens”: 1500
        },
        “response.status”: 200,
        “relationship.type”: “llm_interaction”
      }
    },
    {
      “spanID”: “evaluation_span_1”,
      “parentSpanID”: “decision_span_1”, // Another child of planning
decision
      “operationName”: “agent.decision.goal_evaluation”,
      “startTime”: “2023-01-01T00:00:00.045Z”,
      “duration”: 20000,
      “tags”: {
        “evaluation.metrics”: {
          “completion_rate”: 0.95,
          “accuracy”: 0.89,
          “goal_alignment”: “high”
        },
        “decision.adjustments”: {
          “refinement_needed”: false,
          “confidence_threshold”: “met”
        }
      }
    }
  ],
  “metadata”: {
    “agent.version”: “1.0.0”,
    “agent.type”: “financial_analyst”,
    “execution.context”: “automated_report_analysis”,
    “trace.completion_status”: “success”
  }
}
```

Subprocess 330, which may be implemented by trace engine 116, may generate an operation trace structure based on the trace in the telemetry data, obtained in subprocess 310. The operation trace structure may represent an operation subset of the plurality of spans, in the trace, that represent executive operations performed by AI agent 160 during execution. In other words, the operation trace structure may comprise the spans that have been classified as operation-level. The operation trace structure captures the detailed execution activities of AI agent 160, with a focus on how AI agent 160 interacts with tools 164 and/or application programming interfaces 163, transforms data, handles errors, and/or the like. The operation layer bridges high-level strategic decisions with implementation details, providing critical visibility into the operational activities of AI agent 160.

In an embodiment, the operation trace structure is organized into domains that capture different aspects of the execution of AI agent 160. In particular, each of the spans in the operation subset may be classified into one of these domains. For example, the domains at the operation level may comprise tool operations (e.g., selection, configuration, etc.), API calls (e.g., preparation, execution, etc.), data transformation operations, error handling and/or recovery, and metadata. Thus, the operation subset of spans may include operations that represent one of these domains.

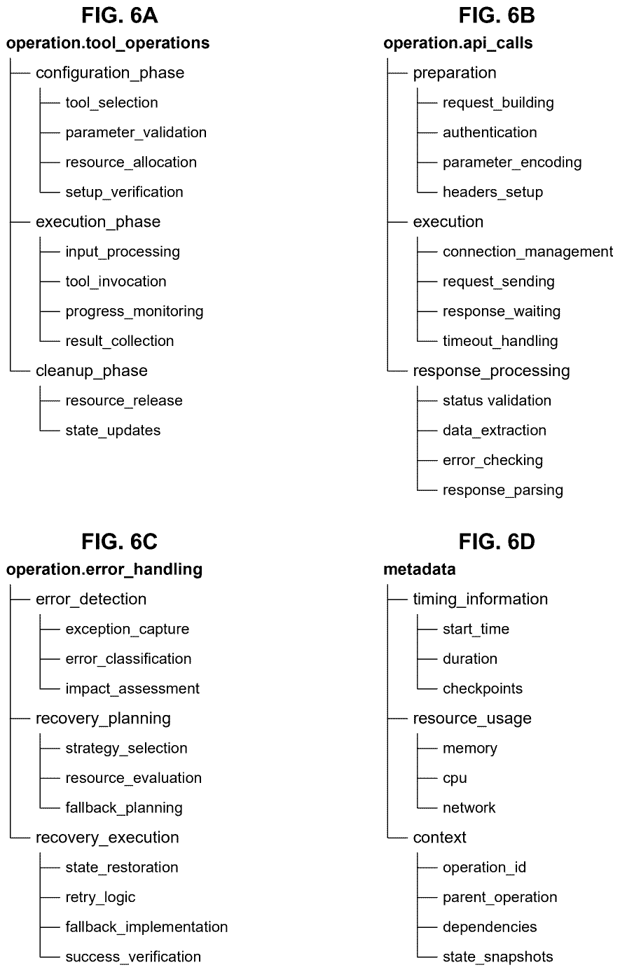

The domain of tool operations documents how AI agent 160 configures each tool 164 that is used, executes each tool 164 that is used, and cleans up after using each tool 164. FIG. 6A illustrates an example organization of the operation trace structure for the domain of tool operations, according to an embodiment. In particular, the domain of tool operations may comprise the configuration phase (“configuration_phase”) which represents how AI agent 160 configured each tool 164, the execution phase (“execution_phase”) which represents how AI agent 160 executed each tool 164, and the clean-up phase (“cleanup_phase”) which represents how AI agent 160 cleaned up after the execution of each tool 164. The configuration phase may include selection of each tool 164 (“tool_selection”), validation of input parameters to tool 164 (“parameter_validation”), allocation of computational resources to tool 164 (“resource allocation”), and verification of the setup of tool 164 (“setup_verification”). The execution phase may include input processing (“input_processing”), tool invocation (“tool_invocation”), progress monitoring (“progress_monitoring”), and result collection (“result_collection”). The clean-up phase may include the release of computational resources allocated to tool 164 (“resource_release”), and state updates (“state_updates”).

The domain of API calls records how AI agent 160 prepares each call to an application programming interface (e.g., application programming interface 163), executes the API call, and processes external API interactions. FIG. 6B illustrates an example organization of the operation trace structure for the domain of API calls, according to an embodiment. In particular, the domain of API calls may comprise preparation of an API call (“preparation”), execution of the API call (“execution”), and processing of the response to the API call (“response_processing”). Preparation may include building of the API call (“request_building”), authentication with the application programming interface (“authentication”), encoding of parameters (“parameter_encoding”), and setup of the headers (“headers_setup”). Execution may include connection management (“connection_management”), sending of the API call (“request_sending”), waiting for the response to the API call (“response_waiting”), and timeout handling (“timeout_handling”). Response processing may include status validation (“status_validation”), extraction of data from the response (“data_extraction”), error checking of the extracted data (“error_checking”), and parsing the response (“response_parsing”).

The domain of error handling documents how AI agent 160 detects errors, plans for errors, and recovers from errors. FIG. 6C illustrates an example organization of the operation trace structure for the domain of error handling, according to an embodiment. In particular, the domain of error handling may comprise error detection (“error_detection”), planning for error recovering (“recovery_planning”), and execution of the error recovery (“recovery_execution”). Error detection may include capturing of exceptions (“exception_capture”), classification of errors (“error_classification”), and impact assessment of errors (“impact_assessment”). Recovery planning may include strategy selection for error recovery (“strategy_selection”), resource evaluation (“resource_evaluation”), and fallback planning (“fallback_planning”). Recovery execution may include restoring the state of AI agent 160 (“state_restoration”), retry logic (“retry_logic”), fallback implementation (“fallback_implementation”), and verification of successful recovery (“success_verification”).

The metadata provide context and performance insights for the operation layer of AI agent 160. FIG. 6D illustrates an example organization of the metadata in the operation trace structure, according to an embodiment. The metadata, tracked for each operation in the operation layer of AI agent 160, may comprise timing information of the operation (“timing_information”), resource usage for the computational resources utilized by the operation (“resource_usage”), and the context of the operation (“context”). Timing information may include the start time of the operation (“start_time”), time duration for the operation (“duration”), and one or more checkpoints in the operation (“checkpoints”). Resource usage may include memory usage by the operation (“memory”), CPU usage by the operation (“cpu”), and network usage by the operation (“network”). Context may include an operation identifier of the operation (“operation_id”), operation identifier of a parent operation if any (“parent_operation”), one or more dependencies of the operation (“dependencies”), and one or more snapshots of the state of AI agent 160 (“state_snapshots”).

A concrete, non-limiting, and illustrative example of an operation trace structure is provided below:

```
{
  “traceID”: “agent_op_789”,
  “spans”: [
    {
      “spanID”: “tool_op_1”,
      “parentSpanID”: “decision_span_1”,
      “operationName”: “operation.tool_operation.configuration_phase”,
      “startTime”: “2023-01-01T10:00:00Z”,
      “duration”: 45000,
      “tags”: {
        “operation_type”: “tool_operation”,
        “phase”: “configuration_phase”,
        “operation_id”: “op_1”,
        “parent_operation”: null,
        “initial_state”: {
          “memory_usage”: 0,
          “cpu_usage”: 0,
          “network_usage”: 0,
          “active tools”: [ ]
        },
        “pre_resources”: {
          “memory”: 0,
          “cpu”: 0,
          “network”: 0
        },
        “success”: true,
        “result_summary”: {
          “name”: “data_analyzer”,
          “parameters”: {
            “precision”: “high”,
            “max_items”: 100
          },
          “status”: “configured”
        },
        “duration”: 0.045,
        “final_state”: {
          “memory_usage”: 50,
          “cpu_usage”: 0,
          “network_usage”: 0,
          “active_tools”: [
            {
              “name”: “data_analyzer”,
              “parameters”: {
                “precision”: “high”,
                “max_items”: 100
              },
              “status”: “configured”
            }
          ]
        },
        “post_resources”: {
          “memory”: 50,
          “cpu”: 0,
          “network”: 0
        },
        “resource_delta”: {
          “memory”: 50,
          “cpu”: 0,
          “network”: 0
        }
      }
    },
    {
      “spanID”: “tool_op_2”,
      “parentSpanID”: “tool_op_1”,
      “operationName”: “operation.tool_operation.execution_phase”,
      “startTime”: “2023-01-01T10:00:00.050Z”,
      “duration”: 120000,
      “tags”: {
        “operation_type”: “tool_operation”,
        “phase”: “execution_phase”,
        “operation_id”: “op_2”,
        “parent_operation”: “op_1”,
        “initial_state”: {
          “memory_usage”: 50,
          “cpu_usage”: 0,
          “network_usage”: 0,
          “active_tools”: [
            {
              “name”: “data_analyzer”,
              “parameters”: {
                “precision”: “high”,
                “max_items”: 100
              },
              “status”: “configured”
            }
          ]
        },
        “pre_resources”: {
          “memory”: 50,
          “cpu”: 0,
          “network”: 0
        },
        “success”: true,
        “result_summary”: {
          “tool”: “data_analyzer”,
          “output”: “Processed 3 items with data_analyzer”,
          “status”: “success”
        },
        “duration”: 0.12,
        “final_state”: {
          “memory_usage”: 150,
          “cpu_usage”: 0.2,
          “network_usage”: 0,
          “active_tools”: [
            {
              “name”: “data_analyzer”,
              “parameters”: {
                “precision”: “high”,
                “max_items”: 100
              },
              “status”: “executed”
            }
          ]
        },
        “post_resources”: {
          “memory”: 150,
          “cpu”: 0.2,
          “network”: 0
        },
        “resource_delta”: {
          “memory”: 100,
          “cpu”: 0.2,
          “network”: 0
        }
      }
    },
    {
      “spanID”: “api_op_1”,
      “parentSpanID”: “decision_span_1”,
      “operationName”: “operation.api_call.preparation”,
      “startTime”: “2023-01-01T10:00:00.200Z”,
      “duration”: 30000,
      “tags”: {
        “operation_type”: “api_call”,
        “phase”: “preparation”,
        “operation_id”: “op_4”,
        “parent_operation”: null,
        “initial_state”: {
          “memory_usage”: 100,
          “cpu_usage”: 0,
          “network_usage”: 0,
          “api_connections”: [ ]
        },
        “pre_resources”: {
          “memory”: 100,
          “cpu”: 0,
          “network”: 0
        },
        “success”: true,
        “result_summary”: {
          “endpoint”: “https://api.example.com/data”,
          “params”: {
            “query”: “sample”
          },
          “headers”: {
            “Authorization”: “Bearer token123”
          },
          “status”: “prepared”
        },
        “duration”: 0.03,
        “final_state”: {
          “memory_usage”: 120,
          “cpu_usage”: 0,
          “network_usage”: 0,
          “api_connections”: [
            {
              “endpoint”: “https://api.example.com/data”,
              “params”: {
                “query”: “sample”
              },
              “headers”: {
                “Authorization”: “Bearer token123”
              },
              “status”: “prepared”
            }
          ]
        },
        “post_resources”: {
          “memory”: 120,
          “cpu”: 0,
          “network”: 0
        },
        “resource_delta”: {
          “memory”: 20,
          “cpu”: 0,
          “network”: 0
        }
      }
    },
    {
      “spanID”: “error_op_1”,
      “parentSpanID”: “api_op_2”,
      “operationName”: “operation.error_handling.error_detection”,
      “startTime”: “2023-01-01T10:00:00.290Z”,
      “duration”: 15000,
      “tags”: {
        “operation_type”: “error_handling”,
        “phase”: “error_detection”,
        “operation_id”: “op_6”,
        “parent_operation”: “op_5”,
        “initial_state”: {
          “memory_usage”: 120,
          “cpu_usage”: 0,
          “network_usage”: 50
        },
        “pre_resources”: {
          “memory”: 120,
          “cpu”: 0,
          “network”: 50
        },
        “success”: true,
        “result_summary”: {
          “error_class”: “timeout_error”,
          “severity”: “high”,
          “context”: {
            “operation_type”: “api_call”,
            “phase”: “execution”
          }
        },
        “duration”: 0.015,
        “final_state”: {
          “memory_usage”: 120,
          “cpu_usage”: 0,
          “network_usage”: 50
        },
        “post_resources”: {
          “memory”: 120,
          “cpu”: 0,
          “network”: 50
        },
        “resource_delta”: {
          “memory”: 0,
          “cpu”: 0,
          “network”: 0
        }
      }
    },
    {
      “spanID”: “error_op_2”,
      “parentSpanID”: “error_op_1”,
      “operationName”: “operation.error_handling.recovery_planning”,
      “startTime”: “2023-01-01T10:00:00.305Z”,
      “duration”: 10000,
      “tags”: {
        “operation_type”: “error_handling”,
        “phase”: “recovery_planning”,
        “operation_id”: “op_7”,
        “parent_operation”: “op_6”,
        “success”: true,
        “result_summary”: {
          “strategy”: “retry_with_backoff”,
          “max_retries”: 3,
          “backoff_factor”: 2
        },
        “duration”: 0.01
      }
    },
    {
      “spanID”: “error_op_3”,
      “parentSpanID”: “error_op_2”,
      “operationName”: “operation.error_handling.recovery_execution”,
      “startTime”: “2023-01-01T10:00:00.315Z”,
      “duration”: 2000000, // Includes backoff sleep time
      “tags”: {
        “operation_type”: “error_handling”,
        “phase”: “recovery_execution”,
        “operation_id”: “op_8”,
        “parent_operation”: “op_7”,
        “success”: true,
        “result_summary”: {
          “action”: “retry”,
          “retry_count”: 1,
          “next_attempt_delay”: 2
        },
        “duration”: 2.0
      }
    },
    {
      “spanID”: “data_op_1”,
      “parentSpanID”: “decision_span_1”,
      “operationName”: “operation.data_transformation.validation_phase”,
      “startTime”: “2023-01-01T10:00:02.500Z”,
      “duration”: 25000,
      “tags”: {
        “operation_type”: “data_transformation”,
        “phase”: “validation_phase”,
        “operation_id”: “op_9”,
        “parent_operation”: null,
        “success”: true,
        “result_summary”: {
          “valid”: true,
          “data”: {
            “firstName”: “John”,
            “lastName”: “Doe”,
            “age”: 30
          }
        },
        “duration”: 0.025
      }
    }
  ],
  “metadata”: {
    “agent.version”: “1.0.0”,
    “agent.type”: “task_processor”,
    “execution.context”: “document_processing”,
    “trace.completion_status”: “partial_success_with_retry”
  }
}
```

Subprocess 340, which may be implemented by trace engine 116, may generate an implementation trace structure based on the trace in the telemetry data, obtained in subprocess 310. The implementation trace structure may represent an implementation subset of the plurality of spans, in the trace, that represent implementing operations performed by AI agent 160 during execution. In other words, the implementation trace structure may comprise the spans that have been classified as implementation-level. The implementation level represents the deepest level of tracing, capturing fine-grained metrics about system performance, resource utilization, and execution details. Thus, the implementation trace structure may provide critical insights for debugging performance, optimizing resource utilization, and understanding the technical behavior of AI agent 160 at the system level.

In an embodiment, the implementation trace structure is organized into domains that capture different aspects of the implementation of sub-tasks by AI agent 160. In particular, each of the spans in the implementation subset may be classified into one of these domains. For example, the domains at the implementation level may comprise performance metrics, technical execution data, memory management, threading concurrency, system resources (e.g., resource utilization), concurrency operations, and metadata. Thus, the implementation subset of spans may include operations that represent one of these domains.

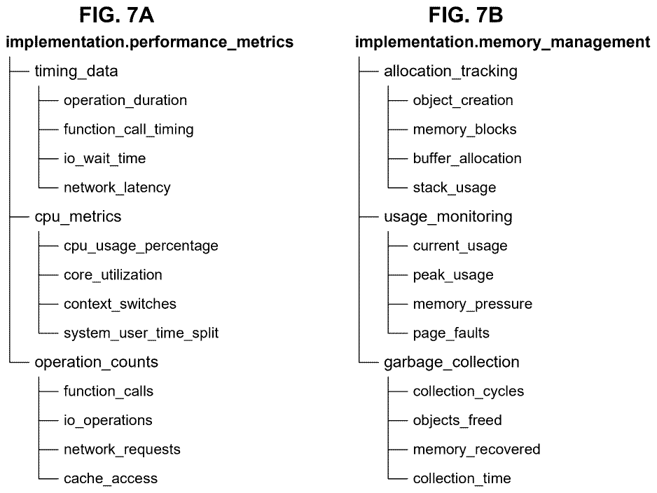

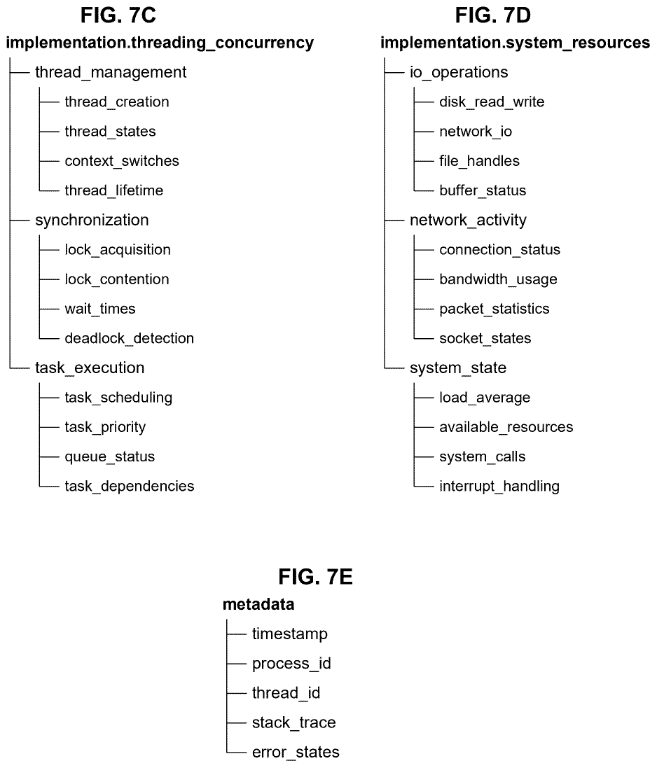

Performance metrics capture detailed data about timing of operations and resource utilization. FIG. 7A illustrates an example organization of the implementation trace structure for the domain of performance metrics. In particular, the domain of performance metrics may comprise timing data which represent the timing of operations (“timing_data”), processing metrics representing CPU utilization by operations (“cpu_metrics”), and the operation counts (“operation_counts”). Timing data for an operation may include the time duration of the operation (“operation_duration”), the timing of function calls (“function_call_timing”), the wait time for input/output operations (“io_wait_time”), and network latency (“network_latency”). Processing metrics may comprise processing utilization percentage (“cpu_usage percentage”), core utilization (“core_utilization”), context switches (“context_switches”), and the system and user time split (“system_user_time_split”). Operation counts may include the number of function calls (“function_calls”), the number of input/output operations (“io_operations”), the number of network requests (“network_requests”), and the number of cache accesses (“cache_access”).

Memory management tracks resource allocation, resource utilization, and garbage collection. FIG. 7B illustrates an example organization of the implementation trace structure for the domain of memory management. In particular, the domain of memory management may comprise allocation tracking for computational resources (“allocation_tracking”), usage monitoring for computational resources (“usage_monitoring”), and garbage collection (“garbage_collection”). Allocation tracking may include object creation (“object_creation”), memory blocks (“memory_blocks”), buffer allocation (“buffer allocation”), and stack usage (“stack_usage”). Usage monitoring may include current memory utilization (“current_usage”), peak memory utilization (“peak_usage”), memory pressure (“memory_pressure”), and page faults (“page_faults”). Garbage collection may include collection cycles (“collection_cycles”), objects freed (“objects_freed’), memory recovered (“memory_recovered”), and collection time (“collection_time”).

The domain of threading concurrency monitors aspects of parallel execution. FIG. 7C illustrates an example organization of the implementation trace structure for the domain of threading concurrency. In particular, the domain of threading concurrency may comprise management of threads (“thread_management”), synchronization of the threads (“synchronization”), and task execution (“text_execution”). Thread management may include thread creation (“thread_creation”), thread states (“thread_states”), context switches (“context_switches”), and thread lifetime (“thread_lifetime”). Synchronization may include lock acquisition (“lock_acquisition”), lock contention (“lock_contention”), wait times (“wait_times”), and deadlock detection (“deadlock_detection”). Task execution may include task scheduling (“task_scheduling”), task priority (“task_priority”), queue status (“queue_status”), and task dependencies (“task_dependencies”).

The domain of system resources tracks inputs and outputs, network activity, and overall system states. FIG. 7D illustrates an example organization of the implementation trace structure for the domain of system resources. In particular, the domain of system resources may comprise I/O operations (“io_operations”), network activity (“network_activity”), and system state (“system_state”). I/O operations may include disk read and write operations (“disk_read_write”), network I/O operations (“network_io”), file handles (“file_handles”), and buffer status (“buffer_status”). Network activity may include connection status (“connection_status”), bandwidth usage (“bandwidth_usage”), packet statistics (“packet_statistics”), and socket states (“socket_states”). System state may include load average (“load_average”), available resources (“available_resources”), system calls (“system_calls”), and interrupt handling (“interrupt_handling”).

The metadata provide context for the implementation layer of AI agent 160. FIG. 7E illustrates an example organization of the metadata in the implementation trace structure, according to an embodiment. The metadata may comprise, for each process of each thread, a timestamp of the process (“timestamp”), an identifier of the process (“process_id”), an identifier of the thread (“thread_id”), a trace of the stack for the process (“stack_trace”), and error states for the process (“error_states”).

A concrete, non-limiting, and illustrative example of an implementation trace structure is provided below:

```
{
  “traceID”: “impl_trace_123”,
  “spans”: [
    {
      “spanID”: “impl_span_1”,
      “parentSpanID”: “op_span 2”,
      “operationName”: “implementation.performance_metrics.timing_data”,
      “startTime”: “2023-01-01T12:00:00Z”,
      “duration”: 205000,
      “tags”: {
        “timestamp”: 1672574400.0,
        “process_id”: 12345,
        “thread_id”: 123456789,
        “stack_trace”: [
          “File \“executor.py\”, line 120, in execute_model_inference\n”,
          “File \”executor.py\”, line 310, in main\n”
        ],
        “execution_time”: 0.205,
        “error”: false
      }
    },
    {
      “spanID”: “impl_span_2”,
      “parentSpanID”: “op_span_2”,
      “operationName”: “implementation.performance_metrics.cpu_metrics”,
      “startTime”: “2023-01-01T12:00:00.210Z”,
      “duration”: 150000,
      “tags”: {
        “timestamp”: 1672574400.21,
        “process_id”: 12345,
        “thread_id”: 123456789,
        “pre.cpu_percent”: 5.2,
        “pre.system_time”: 0.35,
        “pre.user_time”: 1.25,
        “pre.context_switches”: 142,
        “post.cpu_percent”: 95.8,
        “post.system_time”: 0.38,
        “post.user_time”: 1.37,
        “post.context_switches”: 145,
        “delta.cpu_percent”: 90.6,
        “delta.system_time”: 0.03,
        “delta.user_time”: 0.12,
        “delta.context_switches”: 3,
        “execution_time”: 0.15,
        “error”: false
      }
    },
    {
      “spanID”: “impl_span_3”,
      “parentSpanID”: “op_span_3”,
      “operationName”:
“implementation.memory_management.allocation_tracking”,
      “startTime”: “2023-01-01T12:00:00.450Z”,
      “duration”: 80000,
      “tags”: {
        “timestamp”: 1672574400.45,
        “process_id”: 12345,
        “thread_id”: 123456789,
        “pre.object_count”: 12543,
        “post.object_count”: 32578,
        “delta.object_count”: 20035,
        “execution_time”: 0.08,
        “error”: false
      }
    },
    {
      “spanID”: “impl_span_4”,
      “parentSpanID”: “op_span_3”,
      “operationName”: “implementation.memory_management.usage_monitoring”,
      “startTime”: “2023-01-01T12:00:00.535Z”,
      “duration”: 110000,
      “tags”: {
        “timestamp”: 1672574400.535,
        “process_id”: 12345,
        “thread_id”: 123456789,
        “pre.rss”: 52428800, // 50 MB
        “pre.vms”: 104857600, // 100 MB
        “pre.shared”: 8388608, // 8 MB
        “pre.page_faults”: 124,
        “post.rss”: 83886080, // 80 MB
        “post.vms”: 125829120, // 120 MB
        “post.shared”: 8388608, // 8 MB
        “post.page_faults”: 156,
        “delta.rss”: 31457280, // 30 MB increase
        “delta.vms”: 20971520, // 20 MB increase
        “delta.shared”: 0,
        “delta.page faults”: 32,
        “execution_time”: 0.11,
        “error”: false
      }
    },
    {
      “spanID”: “impl_span_5”,
      “parentSpanID”: “op_span_4”,
      “operationName”:
“implementation.threading_concurrency.thread_management”,
      “startTime”: “2023-01-01T12:00:00.750Z”,
      “duration”: 15000,
      “tags”: {
        “timestamp”: 1672574400.75,
        “process_id”: 12345,
        “thread_id”: 123456789,
        “pre.thread_count”: 3,
        “post.thread_count”: 8,
        “delta.thread_count”: 5,
        “execution_time”: 0.015,
        “error”: false
      }
    },
    {
      “spanID”: “impl_span_6”,
      “parentSpanID”: “op_span_4”,
      “operationName”:
“implementation.threading_concurrency.synchronization”,
      “startTime”: “2023-01-01T12:00:00.770Z”,
      “duration”: 55000,
      “tags”: {
        “timestamp”: 1672574400.77,
        “process_id”: 12345,
        “thread_id”: 123456789,
        “execution_time”: 0.055,
        “error”: false
      }
    },
    {
      “spanID”: “impl_span_7”,
      “parentSpanID”: “op_span_5”,
      “operationName”: “implementation.system_resources.io_operations”,
      “startTime”: “2023-01-01T12:00:00.900Z”,
      “duration”: 35000,
      “tags”: {
        “timestamp”: 1672574400.9,
        “process_id”: 12345,
        “thread_id”: 123456789,
        “pre.read_count”: 245,
        “pre.write_count”: 123,
        “pre.read_bytes”: 1048576, // 1 MB
        “pre.write_bytes”: 524288, // 512 KB
        “post.read_count”: 247,
        “post.write_count”: 124,
        “post.read_bytes”: 1064960, // 1.015 MB
        “post.write_bytes”: 541671, // 529 KB
        “delta.read_count”: 2,
        “delta.write_count”: 1,
        “delta.read_bytes”: 16384, // 16 KB
        “delta.write_bytes”: 17383, // 17 KB
        “execution_time”: 0.035,
        “error”: false
      }
    },
    {
      “spanID”: “impl_span_8”,
      “parentSpanID”: “op_span_5”,
      “operationName”: “implementation.system_resources.network_activity”,
      “startTime”: “2023-01-01T12:00:00.940Z”,
      “duration”: 305000,
      “tags”: {
        “timestamp”: 1672574400.94,
        “process_id”: 12345,
        “thread_id”: 123456789,
        “pre.connection_count”: 3,
        “post.connection_count”: 4,
        “delta.connection_count”: 1,
        “execution_time”: 0.305,
        “error”: false
      }
    },
    {
      “spanID”: “impl_span_9”,
      “parentSpanID”: “op_span_5”,
      “operationName”: “implementation.system_resources.system_state”,
      “startTime”: “2023-01-01T12:00:01.250Z”,
      “duration”: 25000,
      “tags”: {
        “timestamp”: 1672574401.25,
        “process_id”: 12345,
        “thread_id”: 123456789,
        “pre.load_average”: [1.2, 1.5, 1.7],
        “pre.available_memory”: 4294967296, // 4 GB
        “post.load_average”: [1.3, 1.5, 1.7],
        “post.available_memory”: 4261412864, // 3.97 GB
        “delta.available_memory”: −33554432, // −32 MB
        “execution_time”: 0.025,
        “error”: false
      }
    },
    {
      “spanID”: “impl span_10”,
      “parentSpanID”: “op_span_3”,
      “operationName”: “implementation.memory_management.garbage_collection”,
      “startTime”: “2023-01-01T12:00:01.300Z”,
      “duration”: 120000,
      “tags”: {
        “timestamp”: 1672574401.3,
        “process_id”: 12345,
        “thread_id”: 123456789,
        “pre.gc_counts”: [10, 3, 1],
        “post.gc_counts”: [0, 0, 0],
        “execution_time”: 0.12,
        “error”: false
      }
    }
  ],
  “metadata”: {
    “agent.version”: “1.0.0”,
    “agent.type”: “model_executor”,
    “execution.context”: “model_inference”,
    “trace.completion_status”: “success”
  }
}
```

The implementation trace structure forms the foundation of the tracing hierarchy. This foundation provides the raw data needed to understand the technical behavior of AI agent 160 at the most detailed level. The combination of the implementation trace structure with the decision trace structure and the operation trace structure create a comprehensive view of the execution of AI agent 160 from high-level reasoning to low-level system interaction. Thus, it should be understood that subprocesses 320, 330, and 340 generate a hierarchical trace structure comprising the decision trace structure, the operation trace structure, and the implementation trace structure. In an alternative embodiment, the hierarchical trace structure may omit either the decision trace structure or the operation trace structure, in which case the respective subprocess 320 or 330 may be omitted.

Subprocess 350 may enrich the hierarchical trace structure (e.g., comprising the decision trace structure, operation trace structure, and/or implementation trace structure) with contextual data. In an embodiment, the contextual data is captured by Contextual Data Capture (CDC). The contextual data may explain why decisions were made in the decision layer, how operations were performed in the operation layer, and what factors influenced the agentic behaviors at each step in the implementation layer of AI agent 160. The contextual data may comprise a snapshot of the state of AI agent 160 at one or more, and generally a plurality of, points in time during the execution of AI agent 160. Each such state snapshot may represent the internal state of AI agent 160 at the respective point in time, conditions of the agentic environment at the point in time, the value of each of one or more relevant variables (e.g., environment variables) at the respective point in time, and/or the like. Additionally or alternatively, the contextual data may comprise a relationship map.

Maintaining the context of AI agent 160 is crucial for understanding the behavior of AI agent 160 during execution of AI agent 160. Thus, in an embodiment, the contextual data comprise one or more state snapshots. In particular, trace engine 116 may capture state snapshots at key points during execution of AI agent 160. Each state snapshot may record environment conditions, variable states, resource availability, and/or the like. The state snapshots provide reference points for debugging and analysis, and enable developers to understand the exact conditions under which decisions were made and actions taken by AI agent 160.

In an embodiment, subprocess 350 may generate one or more semantic tags for each state snapshot, such that each state snapshot comprises the semantic tag(s) generated for that state snapshot. The semantic tag(s) classify the execution steps that are represented in the state snapshot. The semantic tags may be generated by an AI model 162 that is based on Bidirectional Encoder Representations from Transformers (BERT), as disclosed in J. Devlin et al., “BERT: Pre-training of Deep Bidirectional Transformers for Language Understanding,” arXiv: 1810.04805, which is hereby incorporated herein by reference as if set forth in full, or any of its extensions, such as Robustly Optimised BERT pretraining Approach (RoBERTa), RoBERTa-Large, A Lite BERT (ALBERT), Distilled BERT (DistilBERT), StructBERT, or Decoding-enhanced BERT with disentangled Attention (DeBERTa). Alternatively, another language model may be used to generate the semantic tags, such as any small or large language model, including any of the language models mentioned herein. In any case, the AI model 162 that is used to generate the semantic tags may be fine-tuned on agentic execution and operational data. The input to this AI model 162 may be the raw trace data. AI model 162 may operate on both textual descriptions and structured metadata, associated with each trace element, to output semantic tags that provide comprehensive contextual understanding. The semantic tags may classify operations by type and purpose, identify critical decision points, mark potential failure points, categorize errors and exceptions, and/or the like.

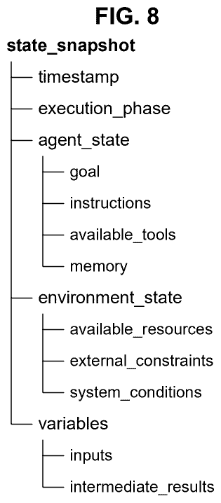

FIG. 8 illustrates an example organization of each state snapshot in the hierarchical trace structure, according to an embodiment. The state snapshot may comprise a timestamp representing the point in time represented by the state snapshot (“timestamp”), an execution phase of AI agent 160 at that point in time (“execution_phase”), the state of AI agent 160 at that point in time (“agent_state”), an environment state of AI agent 160 at that point in time (“environment_state”), and the value of each of one or more variables in AI agent 160 at that point in time (“variables”). The state of AI agent 160 may include the goal of AI agent 160 (“goal”), instructions (“instructions”), tools 164 available to AI agent 160 (“available_tools”), and memory of AI agent 160 (“memory”). Environment state may include computational resources available to AI agent 160 (“available_resources”), external constraints on AI agent 160 (“external_constraints”), and system conditions (“system_conditions”). Variables may include inputs (“inputs”) and intermediate results (“intermediate_results”).

A state snapshot may be captured and added for each span or a subset of spans represented in the hierarchical trace structure. A concrete, non-limiting, and illustrative example of the decision trace structure with integrated state snapshots for each span is provided below:

```
{
  “spanId”: “decision_span_1”,
  “tags”: {
    “decision.stage”: “TASK_PLANNING”,
    “state.snapshot”: {
      “goals”: [“Summarize financial report”],
      “plan”: [
        {“step”: “Extract numbers from PDF”, “status”: “pending”},
        {“step”: “Calculate quarterly trends”, “status”: “pending”},
        {“step”: “Generate summary text”, “status”: “pending”},
        {“step”: “Create charts”, “status”: “pending”}
      ],
      “available_tools”: [“pdf_extractor”, “data_analyzer”,
“text_generator”, “chart_maker”]
    }
  }
},
{
  “spanId”: “decision_span_2”,
  “tags”: {
    “decision.stage”: “TASK_PLANNING”,
    “state.snapshot”: {
      “goals”: [“Summarize financial report”],
      “plan”: [
        {“step”: “Extract numbers from PDF”, “status”: “completed”},
        {“step”: “Clean inconsistent data format”, “status”: “pending”},
        {“step”: “Calculate quarterly trends”, “status”: “pending”},
        {“step”: “Generate summary text”, “status”: “pending”},
        {“step”: “Create charts”, “status”: “pending”}
      ]
    },
    “state.changes”: {
      “plan_modified”: true,
      “steps_added”: [“Clean inconsistent data format”],
      “confidence_change”: −0.2
    }
  }
}
```

In an embodiment, the contextual data, by which the trace structure(s) are enriched in subprocess 350, may comprise a relationship map. Understanding the relationships between different parts of the execution flows, as represented by the trace structure(s), provides for improved debugging and optimization. The relationship map may represent relationships between operations of AI agent 160, including detailed mappings of parent-child relationships between decisions, causal connections between actions, dependencies between different execution steps, cross-reference information for related operations, and/or the like. This relationship map creates a complete picture of how different operations of AI agent 160 interact and influence each other. The relationship map may be generated by a graphical neural network (GNN), which accepts a graph of operations as input, or the like.

In an embodiment, the contextual data, by which the trace structure(s) are enriched in subprocess 350, may comprise performance annotations. The performance annotations may comprise measurements of execution time, measurements of resource utilization, efficiency indicators, identifications of bottlenecks, and/or the like.

Subprocess 350 may generate the relationship map by identifying and analyzing at least four fundamental types of relationships within the operations of AI agent 160: temporal relationships; causal relationships; dependency relationships; and/or semantic relationships. Each type of relationship captures a distinct aspect of agentic behavior and interactions.

Temporal relationships represent the sequential and concurrent execution patterns of agentic operations. Temporal relationships include direct sequence relationships (e.g., a first operation precedes a second operation), parallel execution patterns (e.g., first and second operations execute concurrently), and temporal constraints (e.g., a first operation must complete within X time of a second operation). Temporal relationships may be quantified through timing metrics, execution order statistics, and concurrency patterns.

Causal relationships capture the cause-and-effect chains within agentic operations. Causal relationships identify how decisions lead to actions, how actions impact the state of AI agent 160, and how different operations influence each other. Causal relationships are characterized by direction (e.g., a first operation causes a second operation), strength (e.g., magnitude of impact of an operation), and confidence levels (e.g., the certainty of causation).

Dependency relationships map the interconnections between different components and operations. Dependency relationships include resource dependencies (e.g., an operation requires a particular resource), state dependencies (e.g., an operation depends on a particular state), and data dependencies (e.g., a first operation requires data from a second operation). Dependency relationships may be qualified by criticality, resource requirements, and type of dependency.

Semantic relationships represent functional and logical connections between operations. Semantic relationships capture relationships based on the purpose of the operation, the context of the operation, and the impact of the operation. Semantic relationships may include functional groupings, error chains, and impact patterns.

Subprocess 350 may generate the relationship map via a mapping process that comprises or consists of three phases: identification; classification; and validation. The identification phase identifies relationships, the classification phase classifies the identified relationships, and the validation phase confirms the identified and classified relationships.

The identification phase may comprise an analysis that identifies potential relationships between operations. This analysis may comprise feature extraction, feature engineering, relationship analysis, and causal discovery.

Initially, feature extraction may extract a plurality of features from one or more levels of the trace structure(s). For example, raw trace data representing strategic context and decision rationale may be extracted from the decision trace structure, raw trace data representing execution patterns and resource usage information may be extracted from the operation trace structure, and/or raw trace data representing technical metrics and performance data may be extracted from the implementation trace structure.

Next, feature engineering may transform the raw trace data, extracted from the trace structure(s), into an analyzable pattern represented by a plurality of features. The plurality of features may comprise one or more temporal features, which encode timing and sequence information, one or more contextual features, which encode operational state and environment conditions, and one or more technical features, which encode performance metrics and resource utilization.

Next, relationship analysis and causal discovery may employ one or more, and preferably a plurality of, analytic approaches to detect patterns within the plurality of features. In other words, at least one analysis, and preferably a plurality of analyses, are applied to the plurality of features to identify relationships between operations of AI agent 160. For example, a machine-learning model may be applied to at least a subset of the plurality of features to identify recurring patterns in execution sequences. In an embodiment, the machine-learning model comprises a Recurrent Neural Network (RNN) with long short-term memory (LSTM) for pattern detection in execution sequences. This approach captures long-term dependencies within the operation trace structure, identifying patterns that connect decision rationale to outcomes. The LSTM model processes the sequential nature of the multi-level trace structures, learning the underlying structure that reveals how decisions propagate through execution. Statistical analysis may be applied to at least a subset of the plurality of features and/or the output of the machine-learning model to identify correlation patterns and dependency strengths. Causal discovery algorithms may be applied to at least a subset of the plurality of features and/or the output of the machine-learning model and/or statistical analysis to map the cause-and-effect relationships between operations.

After the identification phase identifies the potential relationships between operations, the classification phase may classify the identified relationships based on type, strength, and impact. This classification may utilize a Gradient Boosting framework that categorizes connections based on type, strength, and operational impact. This approach employs multiple decision trees to achieve high accuracy in distinguishing between different relationship patterns. Notably, relationship strength may be quantified through multiple metrics. Temporal strength measures the consistency of sequence patterns, causal strength indicates the reliability of cause-effect relationships, dependency strength reflects the criticality of dependencies, and semantic strength represents the closeness of functional relationships.

After the classification phase classifies the identified relationships, the validation phase may confirm relationship patterns through statistical analysis and historical data comparison. This validation phase may leverage Bayesian Networks to confirm the identified and classified relationships through probabilistic reasoning. A Bayesian Network models the causal structure underlying the trace data, which enables statistical validation of dependency hypotheses and provides confidence metrics for each identified relationship. The Bayesian Networks may be constructed dynamically based on discovered patterns, to continuously refine the understanding of causal relationships, as new trace data become available.

Subprocess 360 may generate one or more visual elements based on the enriched hierarchical trace structure, output by subprocess 350, which may comprise a decision trace structure, operation trace structure, and/or implementation trace structure. Collectively, these visual element(s) may represent the output of a visual debugging interface of user interface 115, with each visual element representing a different screen or region rendered by the visual debugging interface. The visual debugging interface may retrieve data from the hierarchical trace structure via standard application programming interfaces (e.g., using the query language supported by the collector).

The visual debugging interface may be designed to understand the hierarchical decision-making process of AI agents 160, the relationship between strategic decisions and operations, the causal relationships between reasoning steps and actions, and the context and state transformations throughout execution of AI agents 160. This agent-aware design enables the visual debugging interface to present traces, not just as technical execution paths, but as meaningful cognitive workflows, which makes the “thinking process” of AI agents 160 transparent and debuggable. At a high level, the visual debugging interface translates low-level trace data into meaningful representations of agentic workflows, creating a transparent window into the decision-making process and execution flow of AI agent 160.

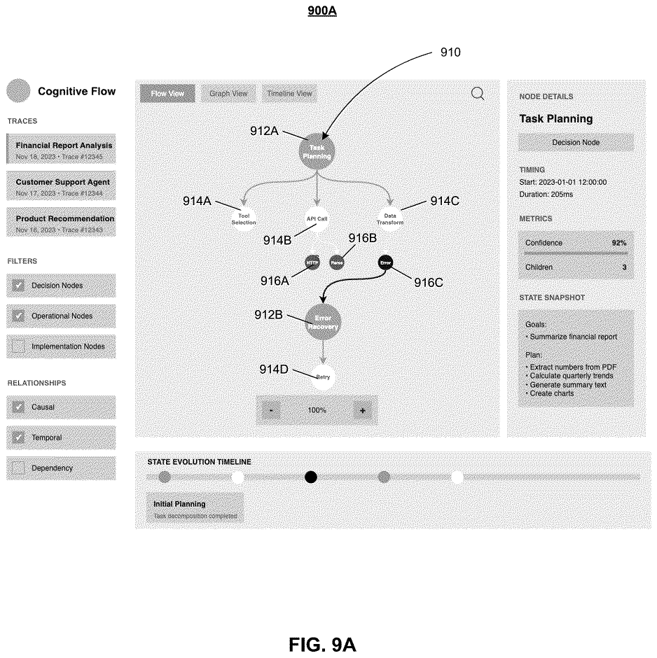

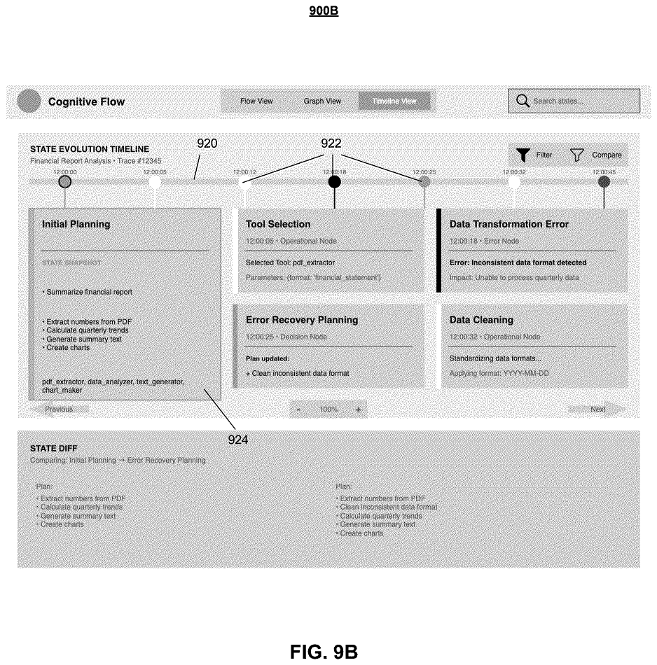

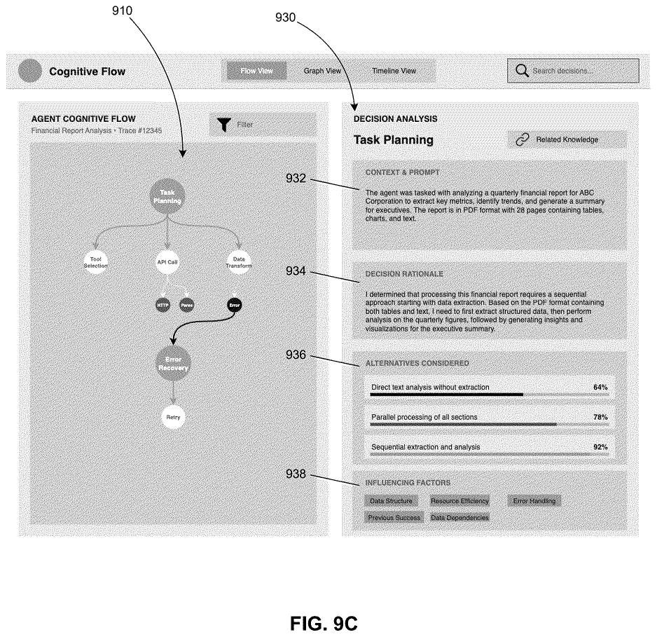

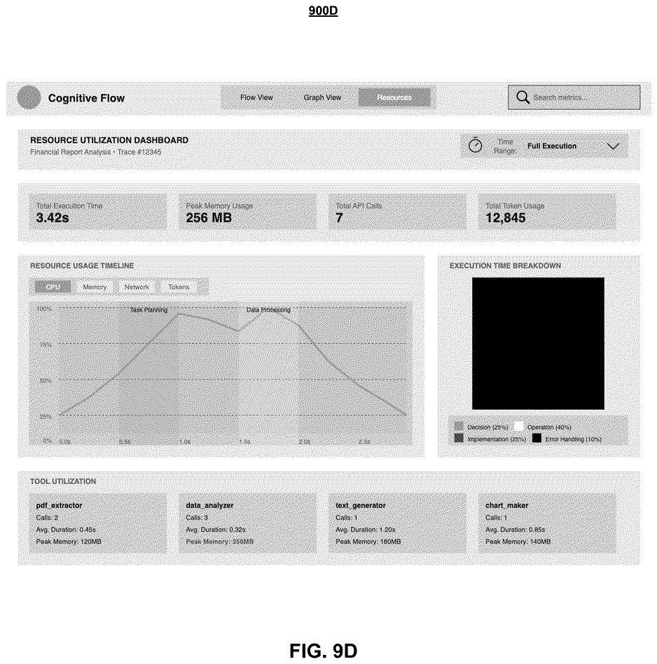

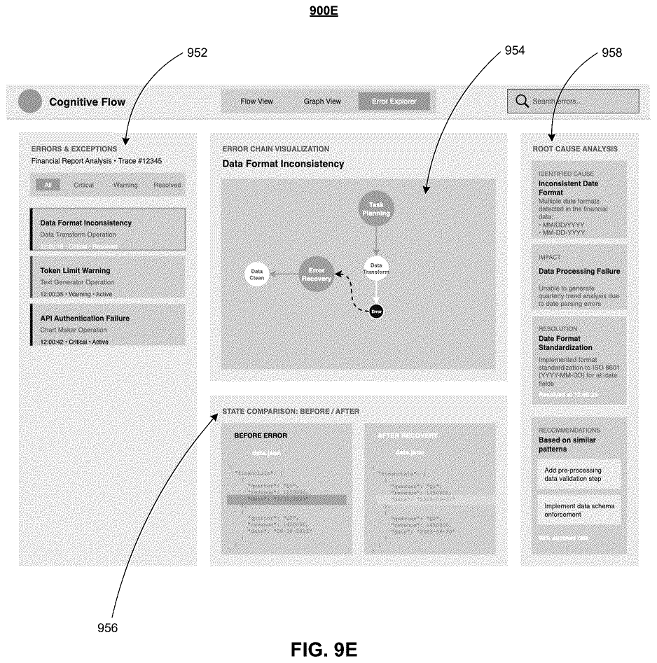

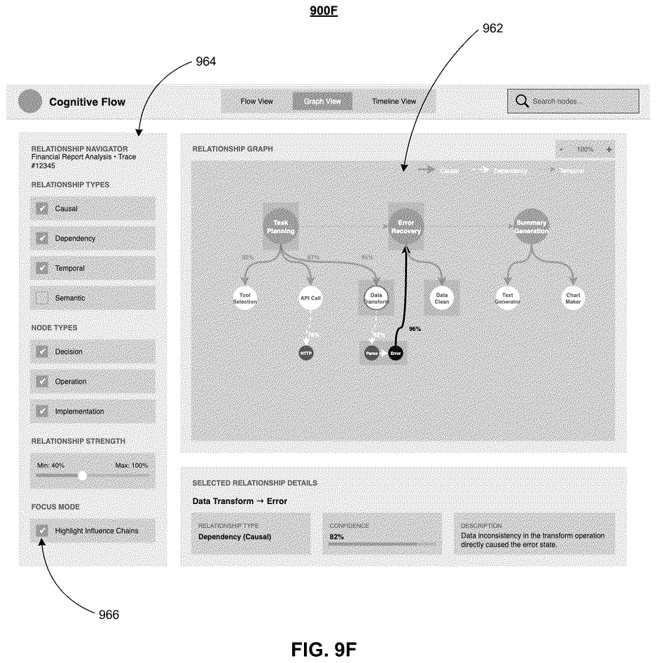

The visual element(s) may comprise an agent cognitive flow visualizer. FIG. 9A illustrates an example of an agent cognitive flow visualizer 900A, according to an embodiment. Agent cognitive flow visualizer 900A may display the hierarchical flow of reasoning by AI agent 160 as an interactive tree or graph 910. Graph 910 may comprise a plurality of nodes, including decision nodes 912 (e.g., derived from the decision trace structure), operation nodes 914 (e.g., derived from the operation trace structure), and/or implementation nodes 916 (e.g., derived from the implementation trace structure), which each represent an operation by AI agent 160. Decision nodes 912 represent strategic decisions, and may be color-coded by the type of decision. The types of decisions may include planning, evaluation, and resource allocation. Operation nodes 914 represent tactical operations, such as tool usage, API calls, and the like. Implementation nodes 916 represent low-level execution details. Graph 910 may also comprise a plurality of directed edges, representing relationships between the plurality of nodes. In particular, each of the plurality of directed edges may connect a pair of nodes and represent a causal relationship between the operations represented by that pair of nodes. In an embodiment, a user can expand or collapse different levels of the hierarchy of nodes in graph 910.

The different types of nodes may be represented in different respective sizes. For example, decision nodes 912 (e.g., 912A and 912B) may be represented in the largest size, operation nodes 914 (e.g., 914A, 914B, 914C, and 914D) may be represented in a medium size between the largest and smallest sizes, and implementation nodes 916 (e.g., 916A, 916B, and 916C) may be represented in the smallest size. In other words, decision nodes 912 are represented in a larger size than operation nodes 914 and implementation nodes 916, and/or operation nodes 914 are represented in a larger size than implementation nodes 916.

The plurality of nodes may comprise visual indications of various parameters. For example, confidence scores may be represented by node opacity, with nodes having high confidence scores (e.g., satisfying a threshold) rendered as opaque or non-transparent, and nodes having low confidence scores (e.g., not satisfying the threshold) rendered as partially transparent. In other words, the transparency of a node may be based on a confidence score for the operation represented by that node. As another example, success and failure states may be represented by the color of the node, with successful operations rendered as green nodes and failed operations rendered as red nodes. In other words, the color of a node may be based on the state of the operation represented by that node. As another example, the duration of operations may be represented in the size of the nodes (e.g., with operations having longer durations represented as larger nodes, and operations having shorter durations represented by smaller nodes) and/or with explicit labels. In other words, the size of a node may be based on the temporal duration of the operation represented by that node. At a higher level, one or more characteristics (e.g., transparency, color, size, and/or the like) of each of the plurality of nodes may be based on one or more parameters of the operation represented by that node.

The plurality of directed edges may be represented with varying thickness, reflecting the strength of the causal relationship represented by that directed edge. For example, an edge representing a stronger causal relationship may be thicker than any edge representing a weaker causal relationship, and an edge representing a weaker causal relationship may be thinner than any edge representing a stronger causal relationship. In other words, the thickness of each of the plurality of directed edges may be based on a strength of the causal relationship represented by that directed edge, with a causal relationship having a higher strength represented by a thicker directed edge than a causal relationship having a lower strength.

The visual element(s) may comprise a state evolution timeline. FIG. 9B illustrates an example of a state evolution timeline 900B, according to an embodiment. State evolution timeline 900B visualizes how the internal state of AI agent 160 evolves throughout execution. State evolution timeline 900B may comprise a timeline 920, which is illustrated as a horizontal timeline, but could alternatively be a vertical timeline or diagonal timeline. State evolution timeline 900B may also comprise a plurality of points 922 positioned on timeline 920. Each of the plurality of points 922 may represent a key state transition, and may be positioned on timeline 920 at a location that is representative of a timing of that state transition relative to the state transitions represented by other ones of the plurality of points 922. One or more of the plurality of points 922 may be decision points. Each decision point may be expandable to reveal a state snapshot 924 of AI agent 160 at the timing of that decision point. State evolution timeline 900B may comprise visual indications of what changed between states, and/or annotations that indicate which decisions or operations triggered state changes. State evolution timeline 900B may also comprise one or more inputs that enable the user to toggle options, so as to focus on specific state components, such as memory, tools, goals, and/or the like.

The visual element(s) may comprise a decision analysis panel. FIG. 9C illustrates an example of a decision analysis panel 930, according to an embodiment. Decision analysis panel 930 provides deep insight into the reasoning of AI agent 160. Decision analysis panel 930 may comprise the prompt and/or context 932 that was used for the decision, a rationale 934 for the decision, alternatives 936 considered for the decision, influencing factors 938 for the decision, and/or the like. Rationale 934 may be extracted from the decision trace structure. Alternatives 936 may be indicated with a comparative score for each alternative that was rejected. Influencing factors 938 may comprise links to relevant parts of the knowledge or memory of AI agent 160.

The visual element(s) may comprise a resource utilization dashboard. FIG. 9D illustrates an example of a resource utilization dashboard 900D, according to an embodiment. Resource utilization dashboard 900D provides performance visualization with agent-specific context. For example, resource utilization dashboard 900D may provide a correlation between decision phases and processor utilization, memory utilization, network utilization, token utilization, and/or the like. Resource utilization dashboard 900D may also provide metrics for resource utilization by each specific tool 164 that is utilized by AI agent 160. Resource utilization dashboard 900D may also provide a breakdown of execution time at the decision level, operation level, and/or implementation level. In addition, resource utilization dashboard 900D may identify bottlenecks in natural language (e.g., “high memory usage during knowledge retrieval phase”).

The visual element(s) may comprise an error and exception explorer. FIG. 9E illustrates an example of an error and exception explorer 900E, according to an embodiment. Error and exception explorer 900E is a specialized view that helps diagnose failures in execution of AI agent 160. Error and exception explorer 900E may comprise a list 952 of all errors and exceptions encountered during execution of AI agent 160. In addition, error and exception explorer 900E may comprise an error chain visualization 954 that illustrate how exceptions propagate through the decision hierarchy, using a graph with nodes and directed edges connecting the nodes. Error and exception explorer 900E may also comprise a recovery attempt visualization 956 that includes state snapshots from both before the recovery attempt and after the recovery attempt. Furthermore, error and exception explorer 900E may comprise a root cause analysis 958 that connects errors to specific decisions or state conditions, and suggests fixes based on successful patterns from other executions.

The visual element(s) may comprise a relationship graph navigator. FIG. 9F illustrates an example of a relationship graph navigator 900F, according to an embodiment. Relationship graph navigator 900F provides visualization of the complex relationships between different parts of the execution of AI agent 160. Relationship graph navigator 900F may comprise an interactive force-directed graph 962 showing causal relationships, dependency relationships, and/or semantic relationships as a plurality of nodes, connected by directed edges. Relationship graph navigator 900F may provide filtering options 964, so that the user may focus on specific types of relationships, specific types of nodes, a range of relationship strength, and/or the like. In addition, relationship graph navigator 900F may provide one or more inputs 966 for highlighting paths representing influence chains (i.e., early decisions that affect later operations). Strength indicators (e.g., colors, line thickness, text labels, etc.) may be employed to depict the confidence of each illustrated relationship.

The visual element(s) may comprise a comparative analysis workbench. The comparative analysis workbench provides a comparison between a plurality of different executions of the same AI agent 160. For example, the comparative analysis workbench may provide a side-by-side visualization of multiple execution traces from AI agent 160. The comparative analysis workbench may also provide difference highlighting that shows divergent decision paths between the different executions. In addition, the comparative analysis workbench may comprise performance comparison charts with statistical significance indicators. The comparative analysis workbench may utilize pattern matching to identify common successful or problematic patterns across the different executions.

The visual element(s) may comprise an agent memory inspector. The agent memory inspector provides visualization of the access patterns of memory and/or knowledge by AI agent 160. Thus, the agent memory inspector may comprise a visualization of memory access patterns during execution, and a visualization of knowledge retrieval by AI agent 160 that shows which information was accessed for which decisions. The agent memory inspector may also provide a list of memory retention events and memory discard events. In addition, the agent memory inspector may provide a representation of the utilization of the context window by LLM-based AI agents 160.

The visual element(s) may comprise a tool usage inspector. The tool usage inspector may provide detailed insights into how AI agent 160 utilizes tool(s) 164. The tool usage inspector may comprise a visualization of the selection decisions for tool(s) 164. The tool usage inspector may also include an analysis of parameter configuration for tool(s) 164. In addition, the tool usage inspector may provide execution results for each tool 164 with success or failure indicators. The tool usage inspector may also provide tool chaining patterns that illustrate how tools 164 are used in sequence.

The visual element(s) may comprise a real-time monitoring dashboard. The real-time monitoring dashboard may provide real-time debugging of running AI agents 160. For example, the real-time monitoring dashboard may provide streaming updates of the current state of AI agent 160 and decisions made by AI agent 160. The real-time monitoring dashboard may also provide real-time alerts of detected anomalies in the execution of AI agent 160. In addition, the real-time monitoring dashboard may provide a progress indicator for the execution of AI agent 160, with an estimated completion time or time duration. The real-time monitoring dashboard may also comprise one or more inputs that enable intervention control by the user, such that the user can pause or redirect execution of AI agent 160.

Subprocess 370 may generate a graphical user interface comprising the visual element(s) generated in subprocess 360, by the visual debugging interface. Separate visual elements may be rendered as separate screens, panels within the same screen, and/or the like. The graphical user interface may comprise inputs for navigating between visual elements, interacting with visual elements, and/or the like.

### 5. EXAMPLE EMBODIMENT

Disclosed embodiments introduce a trace engine 116 that captures and structures the execution paths of AI agents 160, and a visual debugging interface that provides visualization of the execution paths of AI agents 160, as captured and structured by trace engine 116. In an embodiment, trace engine 116 employs a hierarchical tracing mechanism that converts traces into queryable structures that support an interactive visual debugging interface. This significantly improves the transparency, debuggability, explainability, and reliability of AI agents 160 in enterprise environments. Disclosed embodiments address the limitations of state-of-the-art systems by capturing hierarchical execution information, preserving state and context, mapping relationships between operations, and enabling advanced debugging and visualization capabilities.

In typical operation, a user or software entity may initiate execution of an AI agent 160. During execution of AI agent 160, trace engine 116 may capture execution data, from the traces that are generated, and organize the execution data into a queryable and hierarchical trace structure, comprising a decision trace structure, operation trace structure, and/or implementation trace structure. The visual debugging interface may query the hierarchical trace structure to render one or more of the visual elements described herein, which may include dynamic (e.g., expandable/collapsible) execution trees, timeline views of execution sequences, relationship graphs (e.g., visually representing dependencies), interactive debugging, real-time updates, heat maps and/or charts for performance analysis, and/or the like. A user may interact with the visual debugging interface to explore execution paths, and refine AI agent 160 based on the insights garnered from the visual debugging interface. The visual debugging interface may comprise navigation and/or analysis tools, implement pan and zoom functionality for drill-downs into the hierarchical trace structure, provide filter controls for different types of traces, provide search capabilities for specific operations, provide comparison tools for different executions of an AI agent 160, and/or the like. The analysis tools may provide performance profiling views, highlight error patterns, provide visualization of resource utilization, identify bottlenecks, and/or the like.

The above description of the disclosed embodiments is provided to enable any person skilled in the art to make or use the invention. Various modifications to these embodiments will be readily apparent to those skilled in the art, and the general principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly not limited.

As used herein, the terms “comprising,” “comprise,” and “comprises” are open-ended. For instance, “A comprises B” means that A may include either: (i) only B; or (ii) B in combination with one or a plurality, and potentially any number, of other components. In contrast, the terms “consisting of,” “consist of,” and “consists of” are closed-ended. For instance, “A consists of B” means that A only includes B with no other component in the same context.

Combinations, described herein, such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, and any such combination may contain one or more members of its constituents A, B, and/or C. For example, a combination of A and B may comprise one A and multiple B's, multiple A's and one B, or multiple A's and multiple B's.

What is claimed is:

1. A method comprising using at least one hardware processor to, for each of one or more artificial intelligence (AI) agents:
obtain telemetry data for the AI agent executing in a computing environment, wherein the telemetry data comprise a trace for the AI agent, and wherein the trace comprises a plurality of spans that represent operations performed by the AI agent during execution;
by a trace engine, based on the trace, generate a hierarchical trace structure comprising a decision trace structure that represents a decision subset of the plurality of spans that represent decision-making operations performed by the AI agent during execution, an operation trace structure that represents an operation subset of the plurality of spans that represent executive operations performed by the AI agent during execution, and an implementation trace structure that represents an implementation subset of the plurality of spans that represent implementing operations performed by the AI agent during execution;
by the trace engine, enrich the hierarchical trace structure with contextual data;
generate one or more visual elements based on the enriched hierarchical trace structure; and
generate a graphical user interface comprising the one or more visual elements.

2. The method of claim 1, wherein each span in the decision subset of the plurality of spans is classified into one of a plurality of domains.

3. The method of claim 2, wherein the plurality of domains comprises input interpretation, task planning, resource allocation, and goal evaluation.

4. The method of claim 1, wherein each span in the operation subset of the plurality of spans is classified into one of a plurality of domains.

5. The method of claim 4, wherein the plurality of domains comprises tool operations, application programming interface (API) calls, and error handling and recovery.

6. The method of claim 1, wherein each span in the implementation subset of the plurality of spans is classified into one of a plurality of domains.

7. The method of claim 6, wherein the plurality of domains comprises performance metrics, memory management, threading concurrency, and system resources.

8. The method of claim 1, wherein the contextual data comprise a state snapshot of the AI agent at each of one or more points in time during the execution, wherein each state snapshot represents an internal state of the AI agent.

9. The method of claim 8, wherein enriching the hierarchical trace structure with contextual data comprises generating one or more semantics tags for each state snapshot, and wherein each state snapshot comprises the one or more semantic tags generated for that state snapshot.

10. The method of claim 9, wherein the one or more semantic tags are generated by a Bidirectional Encoder Representations from Transformers (BERT)-based AI model.

11. The method of claim 1, wherein the contextual data comprise a relationship map that represents relationships between operations of the AI agent.

12. The method of claim 11, wherein the relationships, represented in the relationship map, comprise temporal relationships, causal relationships, dependency relationships, and semantic relationships.

13. The method of claim 11, wherein enriching the hierarchical trace structure with contextual data comprises generating the relationship map by:
deriving a plurality of features from the hierarchical trace structure, wherein the plurality of features comprise one or more temporal features, one or more contextual features, and one or more technical features;
applying a plurality of analyses to the plurality of features to identify the relationships between operations of the AI agent; and
classifying each of the identified relationships based on type, strength, and impact.

14. The method of claim 1, wherein the one or more visual elements comprise an agent cognitive flow visualizer that comprises an interactive graph representing a hierarchical flow of reasoning by the AI agent, wherein the graph comprises a plurality of nodes and a plurality of directed edges, wherein each of the plurality of nodes represents an operation by the AI agent, and wherein each of the plurality of directed edges connects a pair of the plurality of nodes and represents a causal relationship between the operations represented by that pair of nodes.

15. The method of claim 14, wherein the plurality of nodes comprise decision nodes derived from the decision trace structure, operation nodes derived from the operation trace structure, and implementation nodes derived from the implementation trace structure, and wherein the decision nodes are represented in a larger size than the operation nodes and implementation nodes, and the operation nodes are represented in a larger size than the implementation nodes.

16. The method of claim 14, wherein one or more characteristics of each of the plurality of nodes is based on one or more parameters of the operation represented by that node, and wherein the one or more characteristics comprises at least one of transparency, color, or size.

17. The method of claim 14, wherein a thickness of each of the plurality of directed edges is based on a strength of the causal relationship represented by that directed edge, with a causal relationship having a higher strength represented by a thicker directed edge than a causal relationship with a lower strength.

18. The method of claim 1, wherein the one or more visual elements comprise a state evolution timeline, wherein the state evolution timeline comprises a timeline and a plurality of points, wherein each of the plurality of points represents a state transition and is positioned on the timeline at a location that is representative of a timing of that state transition relative to the state transitions represented by other ones of the plurality of points, and wherein each of one or more of the plurality of points are expandable to reveal a state snapshot of the AI agent at the timing of that point.

19. A system comprising:
at least one hardware processor; and
software that is configured to, when executed by the at least one hardware processor, for each of one or more artificial intelligence (AI) agents,
obtain telemetry data for the AI agent executing in a computing environment, wherein the telemetry data comprise a trace for the AI agent, and wherein the trace comprises a plurality of spans that represent operations performed by the AI agent during execution,
by a trace engine, based on the trace, generate a hierarchical trace structure comprising a decision trace structure that represents a decision subset of the plurality of spans that represent decision-making operations performed by the AI agent during execution, an operation trace structure that represents an operation subset of the plurality of spans that represent executive operations performed by the AI agent during execution, and an implementation trace structure that represents an implementation subset of the plurality of spans that represent implementing operations performed by the AI agent during execution,
by the trace engine, enrich the hierarchical trace structure with contextual data,
generate one or more visual elements based on the enriched hierarchical trace structure, and
generate a graphical user interface comprising the one or more visual elements.

20. A non-transitory computer-readable medium having instructions stored therein, wherein the instructions, when executed by a processor, cause the processor to, for each of one or more artificial intelligence (AI) agents:
obtain telemetry data for the AI agent executing in a computing environment, wherein the telemetry data comprise a trace for the AI agent, and wherein the trace comprises a plurality of spans that represent operations performed by the AI agent during execution;
by a trace engine, based on the trace, generate a hierarchical trace structure comprising a decision trace structure that represents a decision subset of the plurality of spans that represent decision-making operations performed by the AI agent during execution, an operation trace structure that represents an operation subset of the plurality of spans that represent executive operations performed by the AI agent during execution, and an implementation trace structure that represents an implementation subset of the plurality of spans that represent implementing operations performed by the AI agent during execution;
by the trace engine, enrich the hierarchical trace structure with contextual data;
generate one or more visual elements based on the enriched hierarchical trace structure; and
generate a graphical user interface comprising the one or more visual elements.
